(19) United States
(12) Patent Application Publication
(10) Pub. No.: US 2015/0234398 A1
(43) Pub. Date: Aug. 20, 2015

(54) Evolving Interactive Virtual-Physical Hybrid Platforms, Systems, and Methods

(71) Applicant: VISA INTERNATIONAL SERVICE ASSOCIATION, San Francisco, CA (US)

(72) Inventors: Theodore Harris, San Francisco, CA (US); Patrick Faith, Pleasanton, CA (US); Scott Edington, Arlington, VA (US)

(21) Appl. No.: 14/624,210

(22) Filed: Feb. 17, 2015

Related U.S. Application Data
(60) Provisional application No. 61/940,363, filed on Feb. 14, 2014.

(51) Int. Cl. G05D 27/02

(52) U.S. Cl. CPC G05D 27/02

(57) ABSTRACT

Systems, methods, and platforms can be configured to use remote sensors to scan people's facial expressions, sounds, smells as well as outside data such as social feeds to create a situational profile for a designated target zone. This profile is fed into a central control unit which then looks at a target outcome to determine the optimal modification of physical and virtual objects within the target zone.

### PRIORITY AND CROSS-REFERENCES

This application claims priority to U.S. provisional patent application Ser. No. 61/940,363 filed Feb. 14, 2014, entitled “Extendable Robotic Companion.” The entire contents of the aforementioned applications are expressly incorporated by reference herein.

This patent application disclosure document (hereinafter “description” and/or “descriptions”) describes inventive aspects directed at various novel innovations (hereinafter “innovation,” “innovations,” and/or “innovation(s)”) and contains material that is subject to copyright, mask work, and/or other intellectual property protection. The respective owners of such intellectual property have no objection to the facsimile reproduction of the patent disclosure document by anyone as it appears in published Patent Office file/records, but otherwise reserve all rights.

### FIELD

The present innovations are directed generally to robotics, and more particularly to extendable modular robotics.

### BACKGROUND

Robots are increasingly being used to assist us with our everyday tasks. For example, it is not uncommon to find floor-cleaning robots in households that can automatically vacuum the floors around the house. Such robots, however, are manufactured to perform specialized tasks and cannot be easily adapted or reconfigured for a different purpose or function.

Robots today are typically complex electro-mechanical machinery designed to perform particular predetermined functions (e.g., cleaning). Depending on the specific functional requirements, manufacturers design and build tailored robots from the ground-up, including, for example, the robots' structural support, housing, power supply, control logic, mechanical means for movement, means for communication, etc. Due to the proprietary fashion in which robots are designed and built, a robot manufacturer must account for every aspect of the robot and cannot simply focus on a subset of the component needed for the robot to operate. The resulting proprietary robot is typically highly specialized for performing the predetermined function but cannot be readily modified to perform other substantially different tasks. Thus, a modular robot platform allowing flexible integration of various standardized modules is needed.

### SUMMARY

Embodiments disclosed herein provide an extendable and modular robotic architecture to allow a robotic companion to be easily reconfigured to perform different tasks. In some embodiments, a robotic companion may include a base terminal unit and additional modular units that can interchangeably be coupled to the base terminal unit to create different configurations of the robotic companion.

As another example, standardized components work together within the robotic companion. Example components are: batteries, sensors, brain, arms, and basket. In this example, the system allows multiple independent manufactures to create sub-components to a robot. If needed, different companies can enter into the robotics market by specializing on sub components.

As yet another example, a system is disclosed for automatic reconfiguration of robotic furniture components. One or more sensors detect behavior data of multiple users within a region. One or more data processors are configured to process the detected behavior data and to generate a control signal based on the processed behavior data and external data feeds. The control signal is transmitted to one or more of the robotic furniture components to automatically reconfigure.

As another example, a system can be configured to use remote sensors to scan people's facial expressions, sounds, smells as well as outside data such as social feeds to create a situational profile for a designated target zone. This profile is fed into a central control unit which then looks at a target outcome to determine the optimal modification of physical and virtual objects within the target zone. Example physical objects are, lights, speakers, automated furniture, automated merchandize displays, automated mannequins, window treatments, décor and adaptive wall and ceilings. Example virtual objects are social sites, coupons, ads, text messaging. The system adapts these objects within the geographic zone and create unique physical and virtual incentives for people within that zone to help their aggregate mood to move towards a specified end goal. For example, if people seem bored, the system can brighten the light, speed up the tempo of the music, summon entertainment robots and reconfigure décor, walls, ceiling and seating. The system can use adaptive algorithms, advanced sensors, and dynamic sounds, visuals, setting and intelligent devices/robots to create a unique adaptive environment that evolves to either complement or defuse a current situation. The system can be used for a mall or event of big box setting. It could also be purposed for security means opening up access points in case of an emergency, trying to calm bi-standards, providing images to rescue personal. It can behave as a fully automated and autonomous system or understand human guidance.

### BRIEF DESCRIPTION OF THE DRAWINGS

The accompanying appendices and/or drawings illustrate various non-limiting, example, innovative aspects in accordance with the present descriptions:

FIG. 1 illustrates a robotic companion, according to some embodiments.

FIG. 2A illustrates a locomotion modular unit, according to some embodiments.

FIG. 2B illustrates a side view of locomotion modular unit, according to some embodiments.

FIG. 2C illustrates a bottom view of locomotion modular unit, according to some embodiments.

FIG. 2D illustrates a top view of locomotion modular unit, according to some embodiments.

FIG. 3A illustrates a base terminal unit, according to some embodiments.

FIG. 3B illustrates a top view of a base terminal unit, according to some embodiments.

FIG. 3C illustrates a bottom view of a base terminal unit, according to some embodiments.

FIG. 4A illustrates a pedestal unit, according to some embodiments.

FIG. 4B illustrates a top view of a pedestal unit, according to some embodiments.

FIG. 4C illustrates a bottom view of a pedestal unit, according to some embodiments.

FIG. 5A illustrates a general purpose modular unit, according to some embodiments.

FIG. 5B illustrates a top view of a general purpose modular unit, according to some embodiments.

FIG. 5C illustrates a bottom view of a general purpose modular unit, according to some embodiments.

FIG. 6 illustrates one example of a configuration of a robotic companion, according to some embodiments.

FIG. 7 illustrates another example of a configuration of a robotic companion, according to some embodiments.

FIG. 8 illustrates a block diagram of a computing system, according to some embodiments.

FIG. 9 shows a block diagram illustrating the relationships between various components of an embodiment of the presently described extendable robot companion system;

FIGS. 10A-10C illustrate embodiments of a base terminal;

FIGS. 11 illustrates an embodiment of a base terminal coupled to a pedestal;

FIGS. 12A-12F illustrate embodiments of a pedestal;

FIG. 13 illustrates an embodiment of a base terminal, a pedestal, and a locomotion module coupled together;

FIGS. 14A-14D illustrate embodiments of a locomotion module;

FIG. 15 illustrates an embodiment of a base terminal, a pedestal, a locomotion module, and several standardized modules coupled together;

FIGS. 16A-16F illustrate embodiments of a standardized module.

FIGS. 17A-17E embodiments of interconnections between modules and system components.

FIG. 18 illustrates an embodiment of a terminal

FIG. 19 is a block diagram depicting data processing related to the mood analysis.

FIGS. 20-22 are block diagrams depicting additional mood processing examples.

### DETAILED DESCRIPTION

Embodiments of the present invention provides an extendable and modular robotic architecture to enable a robotic companion to be easily reconfigured to serve different purposes. The extendable and modular robotic architecture allows a variety of manufacturers to create custom components or modular units that can be mixed and matched to create compound robots to serve various functions. In some embodiments, a robotic companion may include a base terminal unit, and additional modular units can be coupled to the base terminal unit to create different configurations to serve different purposes or functions. For example, a pedestal unit can be coupled to the base terminal unit, and an interactive display can be coupled to the pedestal unit to create a stationary kiosk. As another example, a locomotion modular unit and a general purpose modular unit outfitted as a shopping basket unit can be coupled to the base terminal unit to create a mobile shopping assistant to carry goods for a consumer around a shopping mall.

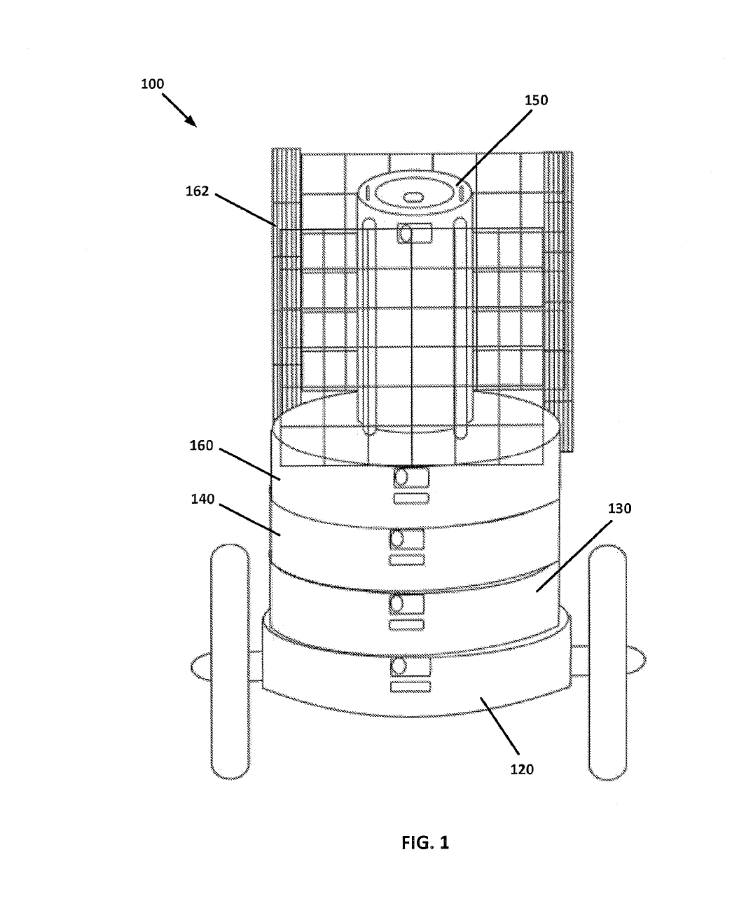

FIG. 1 illustrates a robotic companion 100 according to some embodiments. As shown, robotic companion 100 is configured as a shopping assistant to carry goods for a consumer, for example, around a shopping mall. Robotic companion 100 includes a locomotion modular unit 120, a base terminal unit 130, a general purpose modular unit 140, a shopping basket modular unit 160 (a general purpose modular unit outfitted with a shopping basket 162), and a pedestal unit 150. In some embodiments, locomotion modular unit 120, base terminal unit 130, general purpose modular unit 140, and shopping basket modular unit 160 each has a similar form factor to allow these units to be stacked around the central pedestal unit 150. Although robotic companion 100 is shown with four modular units, it should be understood that in other embodiments, robotic companion 100 may include a different number of modular units. Furthermore, in some embodiments, the ordering of the modular units in robotic companion 100 can be different (e.g., base terminal unit 130 can be arranged above general purpose modular unit 140).

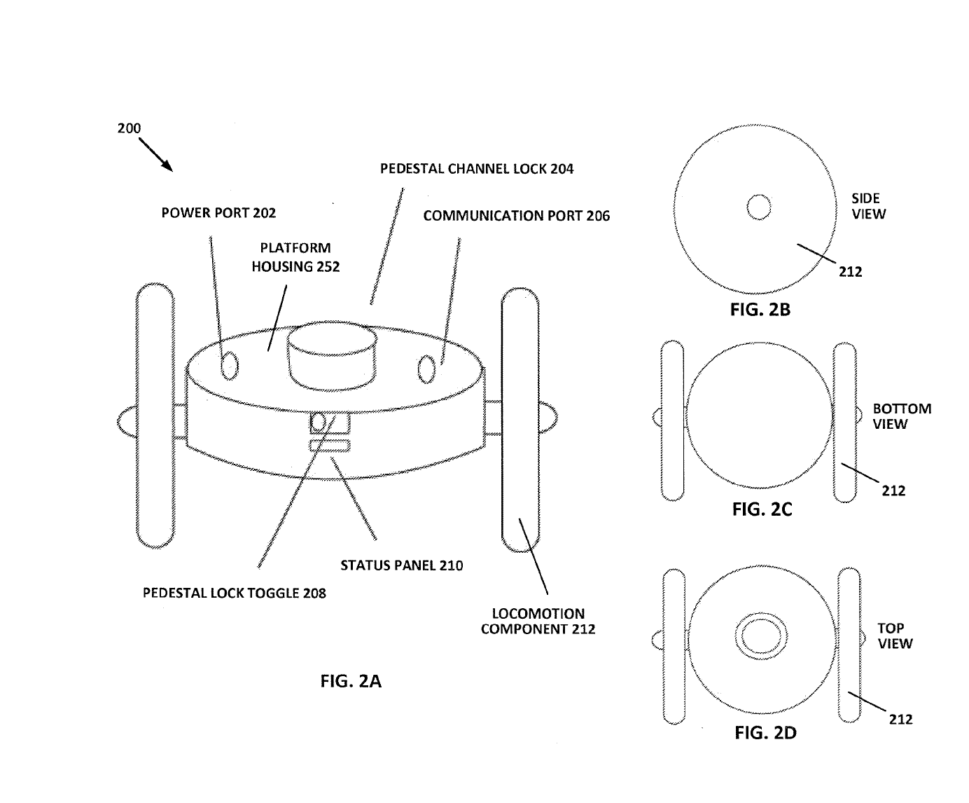

FIG. 2A illustrates a locomotion modular unit 200 according to some embodiments. The side view, bottom view, and top view of locomotion unit modular 200 are illustrated in FIGS. 2B-D, respectively. Locomotion modular unit 200 includes a platform housing 252. As shown, platform housing 252 has a circular cross section, although other cross sectional shapes can be used. In some embodiments, platform housing 252 can be sized similar to the modular units that can be stacked on top of platform housing 252, or be sized larger than the modular units to provide additional support for the modular units stacked above.

Platform housing 252 can include a power port 202, a communication port 206, a pedestal channel lock 204, and a pedestal lock toggle 208. Power port 202 is used to provide locomotion modular unit 200 with power supplied from a base terminal unit. Communication port 206 is used by locomotion modular unit 200 to transmit or receive commands and/or information to and from a base terminal unit. For example, communication port 206 can be used to provide locomotion modular unit 200 with movement commands to direct the motion of the locomotion modular unit 200. In some embodiments, communication port 206 can provide a wireless or wired connection to communicate with other components or modular units of the robotic companion. For example, communication port 206 can be a USB port, although other types of communication ports can be used.

Pedestal channel lock 204 is used to couple locomotion modular unit 200 to a pedestal unit, or a base terminal unit, or another modular unit. In some embodiments, pedestal channel lock 204 is sized complementary to an opening in the pedestal unit, or base terminal unit, or another modular unit such the pedestal channel lock 204 can be inserted into the opening. A locking mechanism can be provided on pedestal channel lock 204 to secure locomotion modular unit 200 to the modular or pedestal unit stacked above. The locking mechanism can be controlled by a pedestal lock toggle switch 208 that can be operated to lock and unlock locomotion modular unit 200 to the modular or pedestal unit stacked above.

In some embodiments, locomotion modular unit 200 can include a status panel 210. Status panel 210 may include lights or other indicators to indicate a status of locomotion unit 200 (e.g., whether locomotion modular unit 200 is securely locked to a modular unit stacked above; whether a communication channel is established between locomotion modular unit 200 and other modular units; whether locomotion modular unit 200 is functioning properly or may require maintenance, etc.).

Locomotion modular unit 200 also includes one or more locomotion components 212 coupled to platform housing 252 to provide the robotic companion with the ability to move from one location to another. For example, in some embodiments, locomotion components 212 may include two wheels that are arranged on each side of platform housing 252. The two wheels can be coupled to platform housing 252 via an axle. In some embodiments, other types of locomotion components such as continuous tracks, robotic legs, etc. can be used.

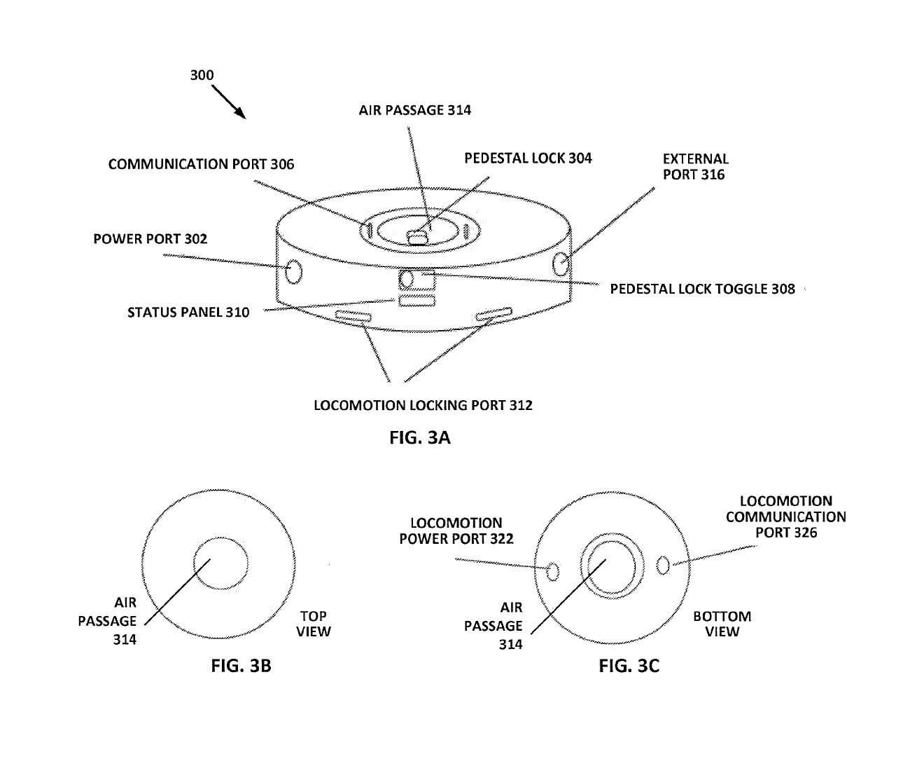

FIG. 3A illustrates a base terminal unit 300 according to some embodiments. The top view and bottom view of base terminal unit 300 are illustrated in FIGS. 3B-C, respectively. In some embodiments, base terminal unit 300 can be sized similar to locomotion modular unit 200, and base terminal unit 300 can be used with or without locomotion modular unit 200.

Base terminal unit 300 can include a power port 302, a communication port 306, a pedestal lock 304, and a pedestal lock toggle 308. In some embodiments, base terminal unit 300 may house a battery for supplying power to the robotic companion including other modular units that may be coupled to base terminal unit 300. Power port 302 may include an input power port to charge the battery of base terminal unit 300. Power port 302 may also include one or more output power port to supply power to other modular units or to an external peripheral or accessory device. In some embodiments, base terminal unit 310 an also include an external port 316 to provide power and/or communication connectivity to an external peripheral or accessory device.

In some embodiments, base terminal unit 300 can house the central computing unit of the robotic companion that is responsible for controlling the various modular units of the robotic companion The central computing unit may include one or more processor, controller, or computing circuits coupled to one or more that store executable code for programming the robotic companion. Base terminal unit 300 can also house additional electronics. For example, base terminal unit 300 can house a GPS unit that can be used to track the location of the robotic companion. The GPS unit can also be used to direct the robotic companion to follow a consumer based on the location of the consumer as provided to a central server or to the robotic companion by a mobile device carried by the consumer.

Communication port 306 can be used to transmit or receive commands and/or information to and from base terminal unit 300. For example, communication port 306 can be used to provide commands or other information to modular units coupled to base terminal unit 300. In some embodiments, communication port 306 can also provide communication connectivity to a central server or to other robotic companions for intelligence sharing, software updates, and remote control of the robotic companion, etc. Communication port 306 can be a wireless or wired connection port. For example, communication port 306 can be a USB port, although other types of communication ports can be used.

Pedestal lock 304 is used to couple base terminal unit 300 to a pedestal unit or to another modular unit. In some embodiments, pedestal lock 304 can be a retractable extension that protrudes into the central opening of base terminal unit 300. Pedestal lock 304 can be controlled by a pedestal lock toggle switch 308 that can be operated to retract or extend pedestal lock 304 to secure base terminal unit 300 to a pedestal unit or to another modular unit. For example, a pedestal unit can be inserted into the central opening of base terminal unit 300 with pedestal lock 304 in the retracted position. Pedestal lock toggle switch 308 can then be actuated to extend pedestal lock 304 into a complementary fitting in the pedestal unit to secure base terminal unit 300 to the pedestal unit. A similar technique can be used to secure base terminal unit 300 to other modular units. According to some embodiments, the central opening in base terminal unit 300 can provide an air passage 314 to cool the components of base terminal unit 300 and allow air to flow to the other modular units of the robotic companion.

In some embodiments, base terminal unit 300 can include a status panel 310. Status panel 310 may include lights or other indicators to indicate a status of base terminal unit 300 (e.g., whether base terminal unit 300 is securely locked to a pedestal unit or another modular unit; whether a communication channel is established between base terminal unit 300 and other modular units or other robotic companions or a central server; whether base terminal unit 300 is functioning properly or may require maintenance, the charge level or battery status of base terminal unit 300, etc.).

According to some embodiments, base terminal unit 300 can be used as a supporting platform of the robotic companion without locomotion modular unit 200, for example, in applications, where robotic companion can be stationary or be placed at a fixed location (e.g., when robotic companion is used as an informational kiosk, as a point-of-sale terminal at a checkout stand, etc.). In some embodiments, base terminal unit 300 can be coupled to locomotion modular unit 200 arranged under base terminal unit 300 to provide mobility for the robotic companion. As such, base terminal unit 300 can include one or more locomotion locking ports 312 to secure base terminal unit 300 to locomotion modular unit 200 below base terminal unit 300. For example, four such locomotion locking ports 312 can be used. Referring to FIG. 3C, the bottom of base terminal unit 300 can also provide a locomotion power port 322 to supply power to locomotion modular unit 200 and a locomotion communication port 326 to communicate with locomotion modular unit 200.

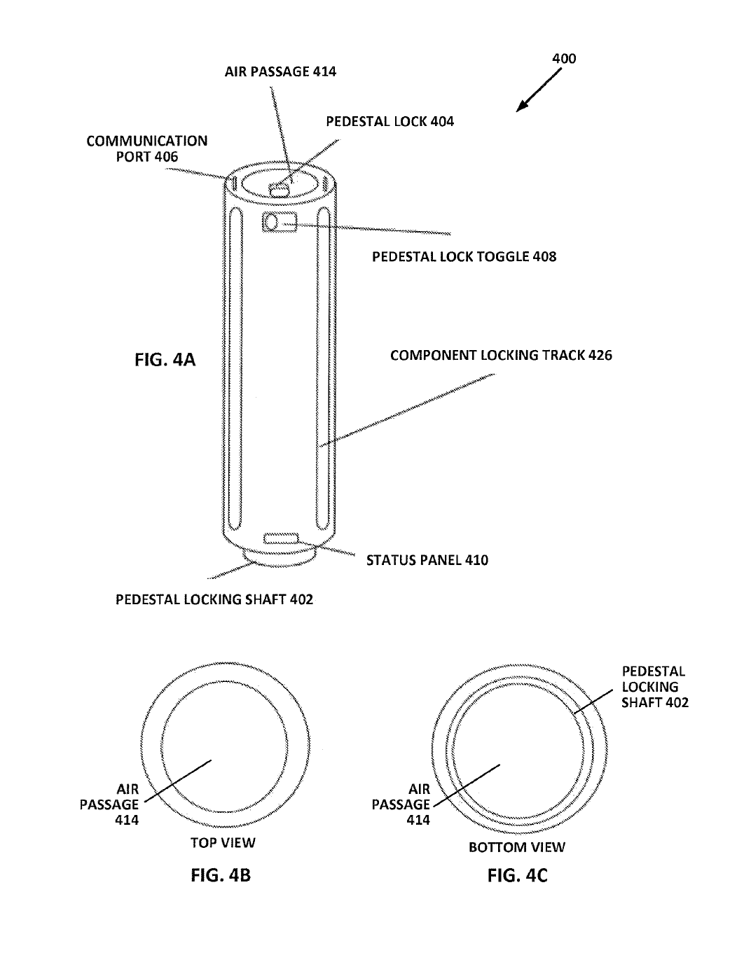

FIG. 4A illustrates a pedestal unit 400 according to some embodiments. The top view and bottom view of pedestal unit 400 are illustrated in FIGS. 4B-C, respectively. Pedestal unit 400 has an elongated body and serves as the central support structure for the modular units of the robotic companion. In some embodiments, pedestal unit 400 is sized complementary to the central opening of the modular units of the robotic companion, and is configured to be inserted into the respective central openings of modular units. It should be understood that in some embodiments of the robotic companion, pedestal unit 400 may not be required, and that in some embodiments, one or more pedestal units 400 can be used (e.g., to extend the height of the robotic companion).

Pedestal unit 400 can include a communication port 406, a pedestal lock 404, a pedestal lock toggle 408, and a pedestal locking shaft 402. Communication port 406 can be used to transmit, receive, and/or relay commands and/or information to and from the stackable modular units or additional pedestal units of the robotic companion. For example, communication port 406 can be used to provide commands or other information from one modular unit to another, or from one pedestal unit to another. In some embodiments, communication port 306 can also provide communication connectivity to peripherals or accessories coupled to pedestal unit 400. Communication port 406 can be a wireless or wired connection port. For example, communication port 406 can be a USB port, although other types of communication ports can be used.

Pedestal lock 404 is used to couple pedestal unit 400 to a modular unit or to another pedestal unit arranged above pedestal unit 400. In some embodiments, pedestal lock 404 can be a retractable extension that protrudes into the central opening of pedestal unit 400. Pedestal lock 404 can be controlled by a pedestal lock toggle switch 408 that can be operated to retract or extend pedestal lock 404 to secure pedestal unit 400 to another pedestal unit or to a modular unit. Pedestal locking shaft 402 is used to couple and secure pedestal unit 400 to a modular unit (e.g., base terminal unit 300) or to another pedestal unit arranged below pedestal unit 400. According to some embodiments, the central opening in pedestal unit 400 can provide an air passage 414 as a passive cooling system to allow air to flow to and cool the modular units of the robotic companion. In some embodiments, an active cooling system can be used (e.g., by providing a liquid cooling system in the central cavity of pedestal unit 400).

Pedestal unit 400 can also include one or more component locking tracks 426. For example, in some embodiments, four component locking tracks 426 can be used. Component locking tracks 426 can be used to secure modular units around pedestal unit 400. For example, component locking tracks 426 can be configured to receive and interlock with the pedestal locks of modular units to secure the modular units to pedestal unit 400. In some embodiments, component locking tracks 426 can provide adjustable locking height positions such that the height of a modular unit can be adjusted. In such embodiments, a stackable modular unit can be hung on the pedestal unit 400 without being in contact with another module unit below. Component locking tracks 426 can also be used to mount peripherals or accessories such as a display (e.g., interactive touchscreen display), a point-of-sale terminal device for processing purchases, a basket to hold goods, a bottle holder, a hook for hanging bags, a baby seat, robotic arms, etc.

In some embodiments, pedestal unit 400 can include a status panel 410. Status panel 410 may include lights or other indicators to indicate a status of pedestal unit 400 (e.g., whether pedestal unit 400 is securely locked to another unit; whether a communication channel is established between pedestal unit 400 and other modular 3 units; whether pedestal unit 400 is functioning properly or requires maintenance, etc.).

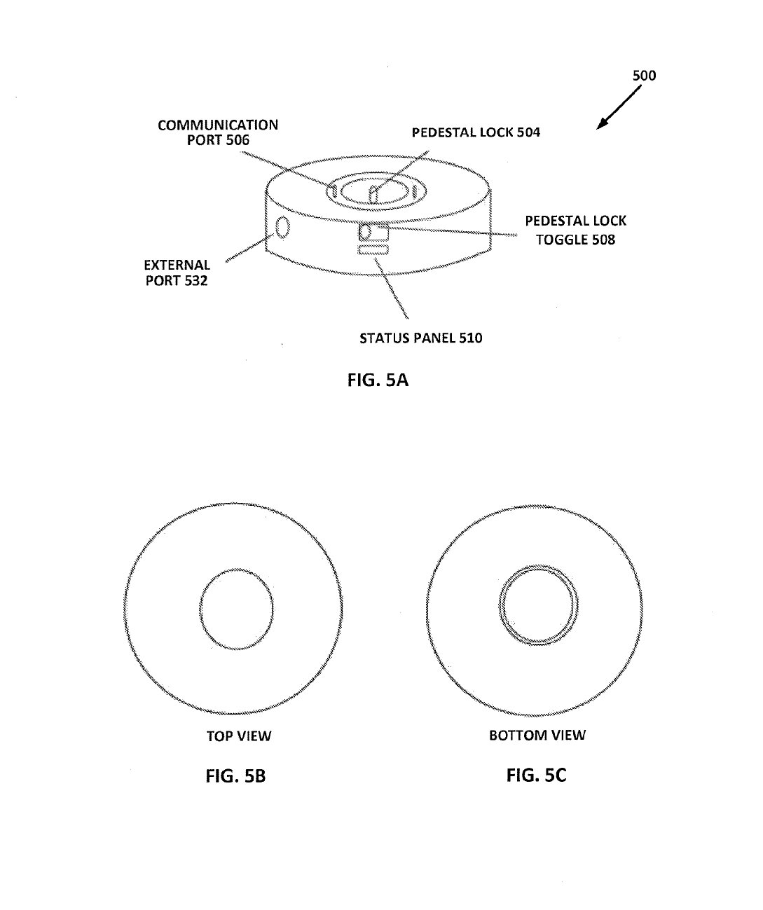

FIG. 5A illustrates a general purpose modular unit 500 according to some embodiments. The top view and bottom view of general purpose modular unit 500 are illustrated in FIGS. 5B-C, respectively. General purpose modular unit 500 can include a power port (not shown), a communication port 506, a pedestal lock 504, and a pedestal lock toggle 508. A power port can be used to supply power to general purpose modular unit 500, for example, from base terminal unit 300. In some embodiments, the power port can be omitted if communication port 506 can be used to supply power to general purpose modular unit 500. In some embodiments, general purpose modular unit 500 may not require power, for example, if general purpose modular unit 500 is used as a purely mechanical component (e.g., to extend the stacked height of the robotic companion).

Communication port 506 can be used to transmit or receive commands and/or information to and from other modular units. For example, communication port 506 can be used to provide commands or other information to modular units coupled to general purpose modular unit 500. Communication port 506 can be a wireless or wired connection port. For example, communication port 506 can be a USB port, although other types of communication ports can be used.

In some embodiments, general purpose modular unit 500 can also include an external port 516 to provide power and/or communication connectivity to an external peripheral or accessory device, or be used to specialize general purpose modular unit 500 for specific functions or tasks. For example, external port 516 can be configured (e.g., via USB or other communication standards) to connect to and charge a mobile device (e.g., mobile phone, tablet, etc.) of a consumer. External port 516 can also be used to send information to a connected mobile device. For example, by connecting a mobile device to external port 532, a consumer may receive coupons or offers on the consumer's mobile device as provide by a central server communicatively coupled to the robotic companion. As another example, external port 516 can be configured to connect o speakers to enable robotic companion to play sounds or audio tunes. External port 516 can be configured to connect to environmental sensors (e.g., camera, microphone, GPS, thermometer, biometric sensors, etc.) to collect environmental information about the surroundings of the robotic companion or of a consumer that the robotic companion is assisting.

Pedestal lock 504 is used to couple general purpose modular unit 500 to a pedestal unit or to another modular unit. In some embodiments, pedestal lock 504 can be a retractable extension that protrudes into the central opening of general purpose modular unit 500. Pedestal lock 504 can be controlled by a pedestal lock toggle switch 508 that is operated to retract or extend pedestal lock 504 to secure general purpose modular unit 500 to a pedestal unit or to another modular unit. For example, a pedestal unit can be inserted into the central opening of general purpose modular unit 500 with pedestal lock 504 in the retracted position. Pedestal lock toggle switch 508 can then be actuated to extend pedestal lock 504 into a component locking track in the pedestal unit to secure general purpose modular unit 500 to the pedestal unit. A similar technique can be used to secure general purpose modular unit 500 to other modular units. According to some embodiments, the central opening in general purpose modular unit 500 can provide an air passage to cool the components of general purpose modular unit 500 and allow air to flow to the other modular units of the robotic companion.

In some embodiments, general purpose modular unit 500 can include a status panel 510. Status panel 510 may include lights or other indicators to indicate a status of general purpose modular unit 500 (e.g., whether general purpose modular unit 500 is securely locked to a pedestal unit or another modular unit; whether a communication channel is established between general purpose modular unit 500 and other modular units or a central server; whether general purpose modular unit 500 is functioning properly or may require maintenance, etc.).

By providing a general purpose modular unit 500 that can be interchangeably coupled to a robotic companion, different manufacturers can create specialized general purpose modular units which can be mixed and matched to create different configurations of a robotic companion. For example, some robotic companions can be configured to stock shelves, while other robotic companions can be configured to vacuum, depending on the particular general purpose modular unit that is provided on the robotic companion.

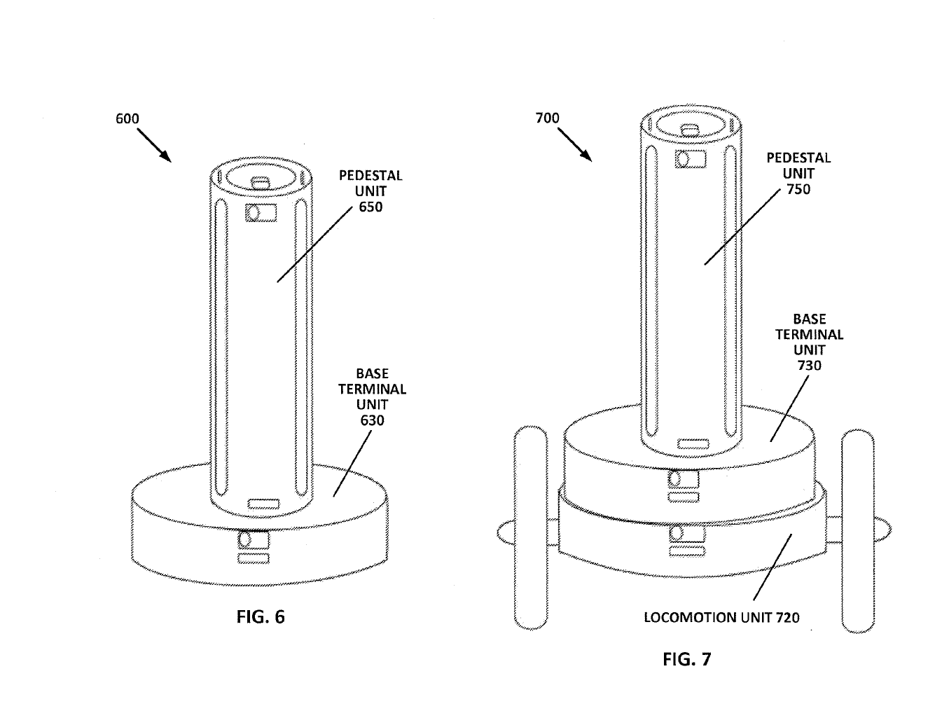

FIG. 6 illustrates one example of a configuration of a robotic companion 600, according to some embodiments. Robotic companion 600 is configured to be stationary or be placed at a fixed location. Robotic companion 600 includes a base terminal unit 630 coupled to a pedestal unit 650. In some embodiments, additional modular units can be stacked or mounted on pedestal unit 650 above base terminal unit 630 to configure robotic companion 600 for specialized tasks.

FIG. 7 illustrates another example of a configuration of a robotic companion 700, according to some embodiments. Robotic companion 700 is configured to be mobile, and can move from one location to another (e.g., follow a consumer around a shopping mall to assist the consumer). Robotic companion 700 includes a locomotion unit 720 coupled to a base terminal unit 730 and a pedestal unit 750. In some embodiments, additional modular units can be stacked or mounted on pedestal unit 750 above base terminal unit 650 to configure robotic companion 700 for specialized tasks.

In some embodiments, a fleet of robotic companions can be deployed in a shopping mall to provide consumers with information and shopping assistant. The fleet of robotic companions can individually or cooperatively create adaptive environments based on inputs such as consumer emotions sensed by sensors on the robotic companion, external news feeds, price changes, or even security threats. For example, a robotic companion may observe a consumer pacing around a shopping mall without making any purchases. Predictive modeling can be used to assess that the consumer is likely to leave the shopping mall soon. With this input, the robotic companion may display or send coupons or offers to the consumer to entice the consumer to remain at the shopping mall. In some embodiments, the robotic companion can communicate with other robotic companions to play sounds, music, lights to create an adaptive environment to try and catch the consumer attention, while the system issues instant target coupons. The sounds being played can incorporate data or other information into music to deliver information to target the user for shopping or data exploration. In some embodiments, the fleet of robotic companions can provide environmental readings such as temperature of various locations within a shopping mall to a central server such that the central sever can adjust the heating, ventilation, and air conditioning system of the shopping mall to create a pleasant environment throughout the mall. In a security setting, the light and sounds played by the robotic companions can be used to calm shoppers or provide shoppers with emergency information such as escape route, and in some embodiments, may lead shoppers along an escape route.

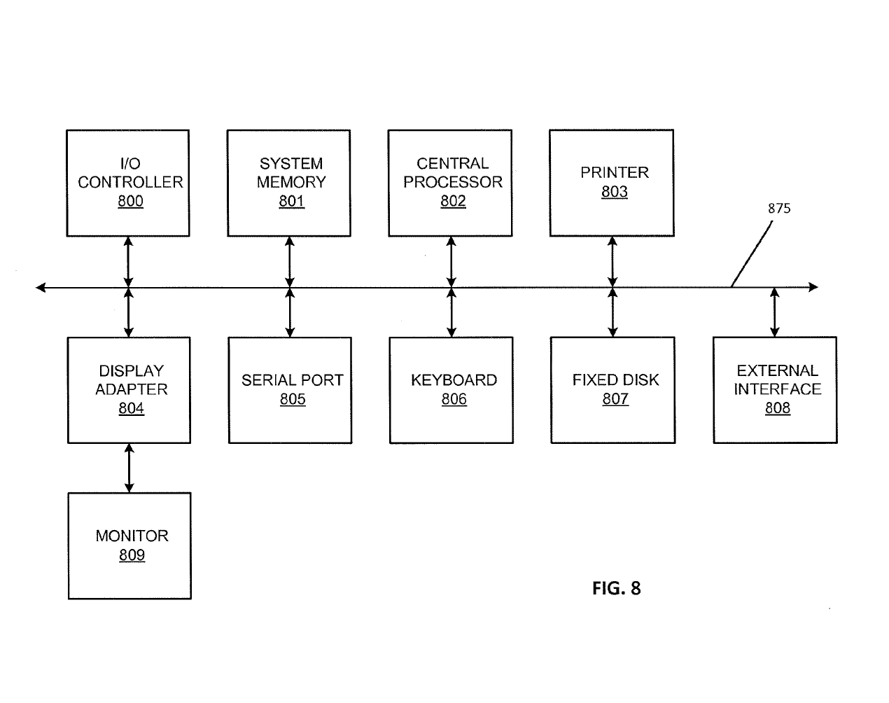

FIG. 8 is a high level block diagram of a computer system that may be used to implement any of the entities or components (e.g., some components of base terminal unit 300, central server, etc.) described above. The subsystems shown in FIG. 8 are interconnected via a system bus 875. Additional subsystems include a printer 803, keyboard 806, fixed disk 807, and monitor 809, which is coupled to display adapter 804. Peripherals and input/output (I/O) devices, which couple to I/O controller 800, can be connected to the computer system by any number of means known in the art, such as a serial port. For example, serial port 805 or external interface 808 can be used to connect the computer apparatus to a wide area network such as the Internet, a mouse input device, or a scanner. The interconnection via system bus 875 allows the central processor 802 to communicate with each subsystem and to control the execution of instructions from system memory 801 or the fixed disk 807, as well as the exchange of information between subsystems. The system memory 801 and/or the fixed disk may embody a computer-readable medium.

As other examples of the wide scope of the systems and methods disclosed herein, The EXTENDABLE ROBOTIC COMPANION system (hereinafter “ERiC”) can be configured to provide a modular robot platform designed to be integrated with robotic modules adhering to a predetermined standard. The platform provides structure and connectivity for the standardized modules to interoperate. For example, the platform may provide an operating system for the ERiC robotic system, physical structure to secure the modules, electricity to energize the modules, and a communication channel through which the modules can communicate and interact with each other and with the platform. Each module connected to the platform may contribute a different functionality towards the overall robot's operational needs. For example, a brain module may be responsible for the robot's control logic or artificial intelligence; a sensory module may be responsible for detecting visual or aural stimuli; a locomotive module may be responsible for the robot's mobility; a purchase-checkout module may be responsible for handling purchase transactions in a point-of-sale setting; a human-interface module may be responsible for interacting with humans, such as shoppers; a security module may be responsible for detecting suspicious objects; a cleaning module may be responsible for cleaning a house; etc. In this example, an ERiC robotic system can allow manufacturers to focus their efforts on designing particular functionalities of a robot without having to expend resources on designing every aspect of the robot. The standardized and modular design of the robotic system would thus encourage third-party innovation.

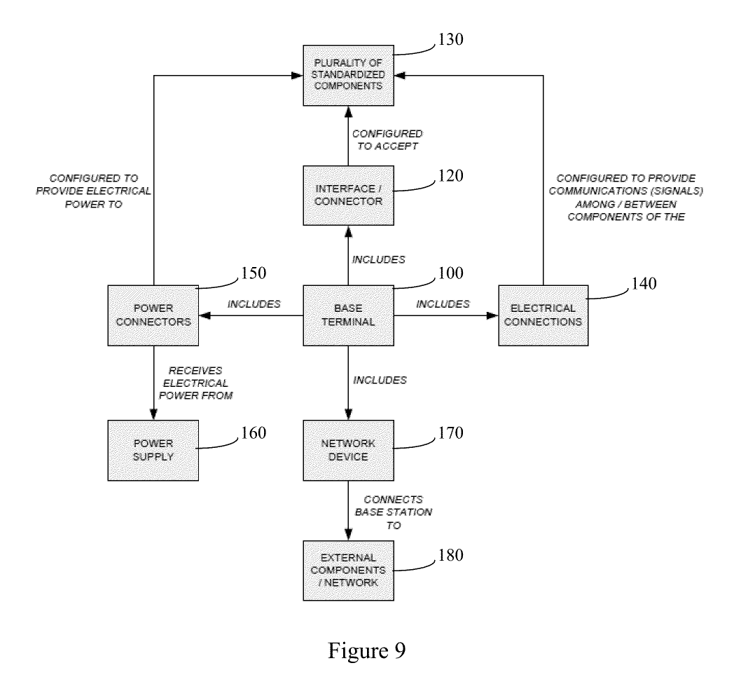

FIG. 9 shows a block diagram of one embodiment of the ERiC system. The base terminal (100) includes one or more interfaces or connectors (120) configured to accept standardized modules (130). Each standardized module (130) may be responsible for a different task, but together the standardized modules (130) and the base terminal (100) operate as a unit to accomplish the intended objective of the robot. For example, a shopping companion robot may have one module responsible for interacting with the shopper, one module for scanning and checking product data, one module for sensing customers who may need help, one module to provide locomotion, and one module to provide a shopping basket.

The base terminal (100) includes electrical connections (140) configured to provide a communication channel for the base terminal (100) and the standardized modules (130). Details of the communication channel will be further described below. The base terminal (100) also includes power connectors (150) configured to supply operating power to the standardized modules (130). The power connector (150) receives power from a power supply (160), which may be a battery, generator, wall outlet, solar, fuel cells, or any other type of power source known in the art.

To communicate with external components or networks (180), the base terminal (100) may be equipped with a network device (170). The network device (170) may establish connection through physical connection or wirelessly (e.g., via Bluetooth, WiFi, cellular, infrared, or any other communication protocol). The type of network that the ERiC system may connect to includes the Internet and Visa's Partner Processing Network for intelligence sharing, software updates, and remote control. In addition, the network device (170) may communicate with standardized modules (130) coupled to the ERiC system.

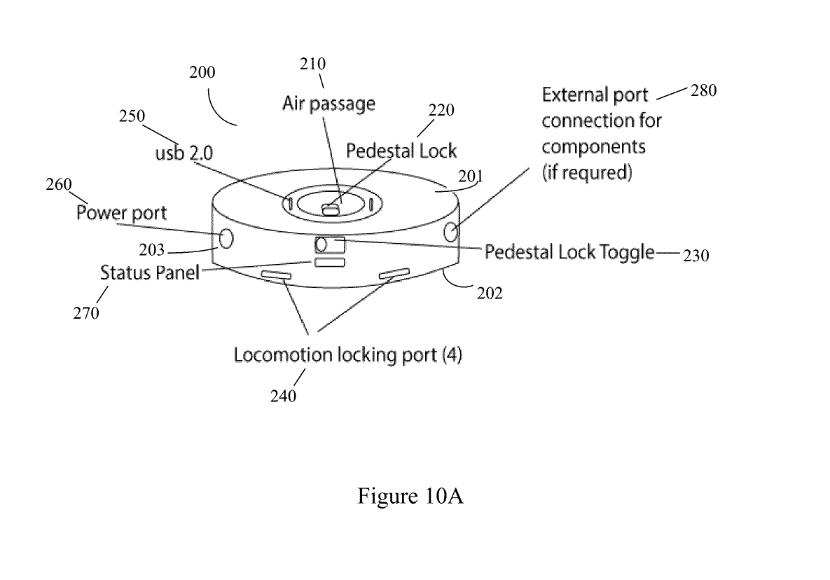

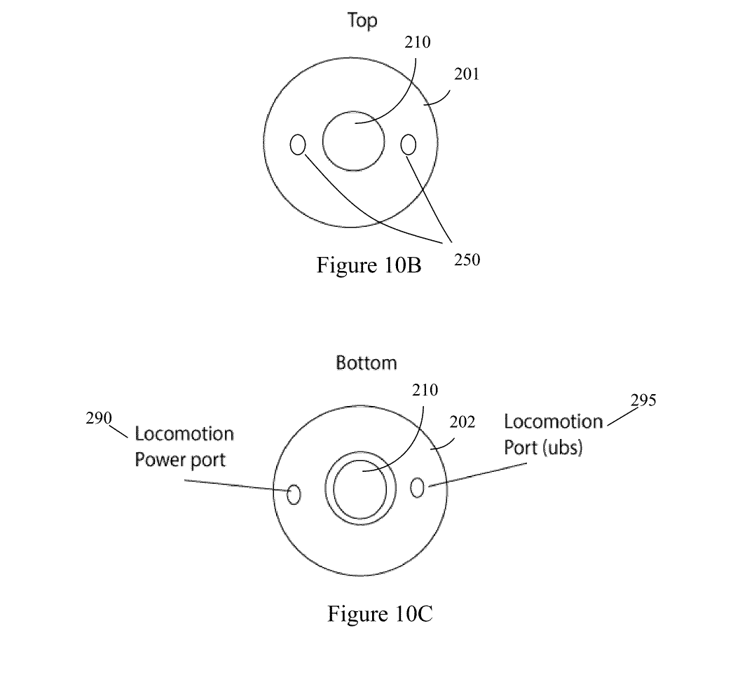

FIG. 10A depicts an embodiment of the base terminal (200). The base terminal's (200) has a cylindrical housing, which has a top surface (201), bottom surface (202), and side surface (203). An air passage hole (210) extends from the top surface (201) to the bottom surface (202) (also depicted in FIGS. 10B and 10C). The air passage hole (210) provides ventilation and cooling for the base terminal (200) and is capable of being coupled to a pedestal (described below). The inside surface of the air passage hole (210) may include pedestal locks (220), which are configured to secure the pedestal to the base terminal (200). On the side surface (203) of the base terminal (200) is a pedestal lock toggle (230) for actuating the pedestal lock (220). The mechanism for controlling the pedestal lock (220) may be mechanical, electrical, or through any other conventional means. The side surface (203) of the base terminal (200) also includes locomotion locking mechanisms (240) for securing the base terminal (200) to a locomotion module, such as wheels or robotic legs. Again, the locking mechanism could be any conventional means.

The base terminal is configured to communicate with other standardized modules (not shown). The communication connection may be through wireless means (e.g., Bluetooth), physical means (e.g., USB ports), or both. FIG. 10A and 10B depict male USB ports (250) located on the top surface (201) of the base terminal (200). The male USB ports (250) are configured to be coupled with female USB ports of any standardized module stacked immediately above the base terminal (200). As shown in FIG. 10C, the bottom surface (202) of the base terminal (200) may similarly have USB ports (295) configured to couple with any standardized module—such as a locomotion module—stacked immediately below the base terminal (200). In another embodiment, the physical communication channels may run through the pedestal instead of ports located on the top (201) and/or bottom (202) surfaces.

The base terminal (200) is also capable of communicating with external components, devices, or networks through any conventional means. The communication may be wireless, such as through WiFi, Bluetooth, radio, infrared, or any other wireless communication standards known in the art. The communication may also be through physical means, in which case the base terminal, as depicted in FIG. 10A, may have an external communication port (280).

The base terminal (200) is capable of providing operating power (e.g., electricity) to any component of the ERiC system. Power may be transmitted wirelessly (e.g., through a magnetic field) or through physical connections. With respect to physical connections, power may be transmitted through the same port used for communication (e.g., USB ports 250) or through a separate connection. A separate power connection may be located on the top (201), bottom (202), or side (203) surface of the base terminal (200) to connect to adjacent modules, or power could be supplied to each module through the pedestal. The power source may be a battery, solar panel, fuel cell, or any other power source known in the art. The embodiment depicted in FIG. 10A shows a power port (260) located on the side surface (203) of the base terminal, which allows the base terminal (200) to be directly connected to an electrical outlet or other external power source.

The base terminal (200) includes a processor and operating system, firmware, or other software that, inter alta, controls and brokerage communications between the base terminal (200) and the connected standardized modules, thus allowing every component to interact with each other. The status of the base terminal (200), as well as any control menu or options, may be displayed on the panel (270) located on the side surface (203). The display panel (270) may also display the status and/or control menu of any connected standardized module or the ERiC system as a whole.

FIG. 10B is a top view of the base terminal (200). The air passage hole (210) is shown to be in the center of the base terminal (200) housing, flanked by USB Ports (250). The configuration of the air passage hole and connection ports adheres to a standard that the standardized modules also adhere to.

FIG. 10C is a bottom view of the base terminal (200). The other end of the air passage hole (210) is shown in the center. The bottom surface (202) may adhere to the same standard configuration as that of the top surface (201). However, if the bottom of the base terminal (200) is expected to be coupled to a locomotion module, the port configuration of the bottom surface (202) may also be different to suit the particular needs of a locomotion module. For example, FIG. 10C shows the bottom surface (202) having a locomotion power port (290) in addition to communication port (295). In any event, the bottom surface (202) adheres to a configuration standard that is adopted by locomotion modules.

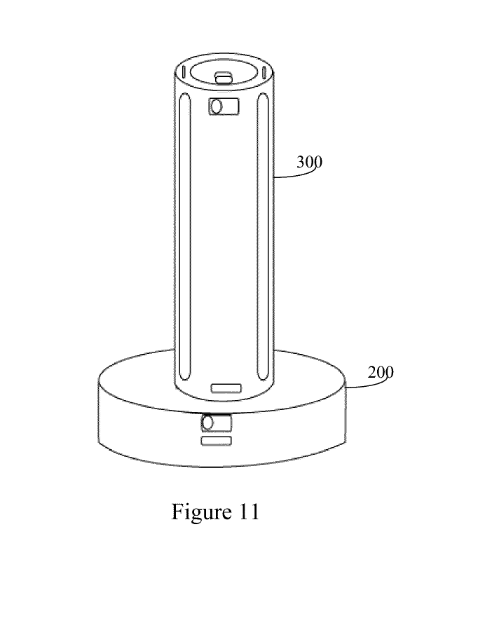

FIG. 11 shows one embodiment of the base terminal (200) coupled to a pedestal (300), which provides structural support, connectivity (e.g., communication and power), and heat exchange for components of the ERiC system. The depicted pedestal (300) extends upward from the base terminal (200) and is configured to accept standardized modules staked on top of the base module (200).

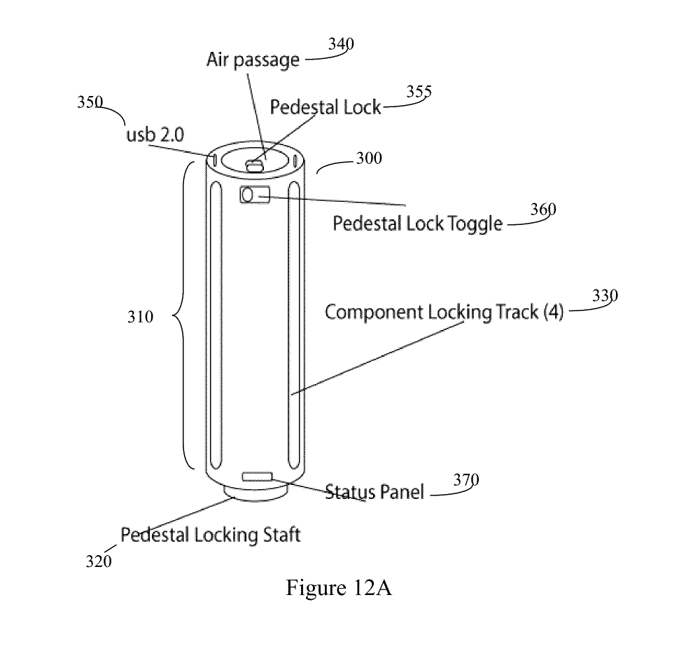

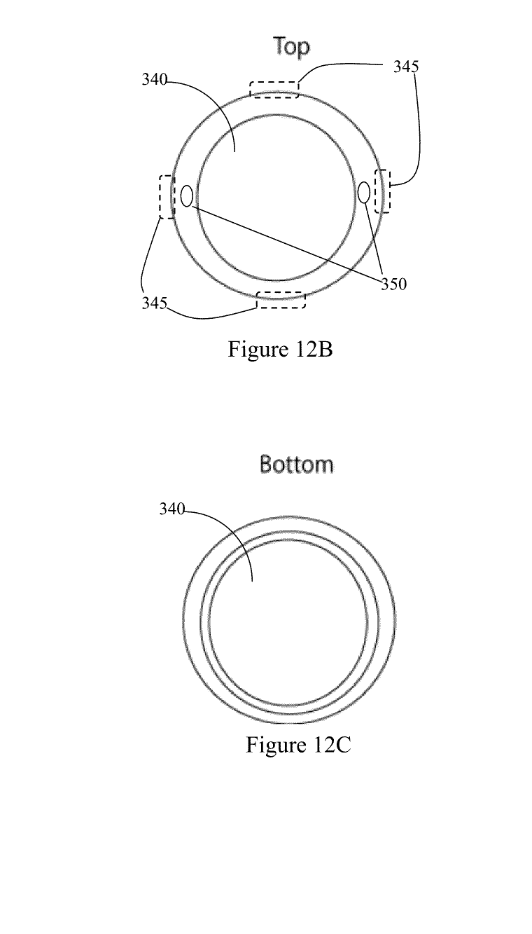

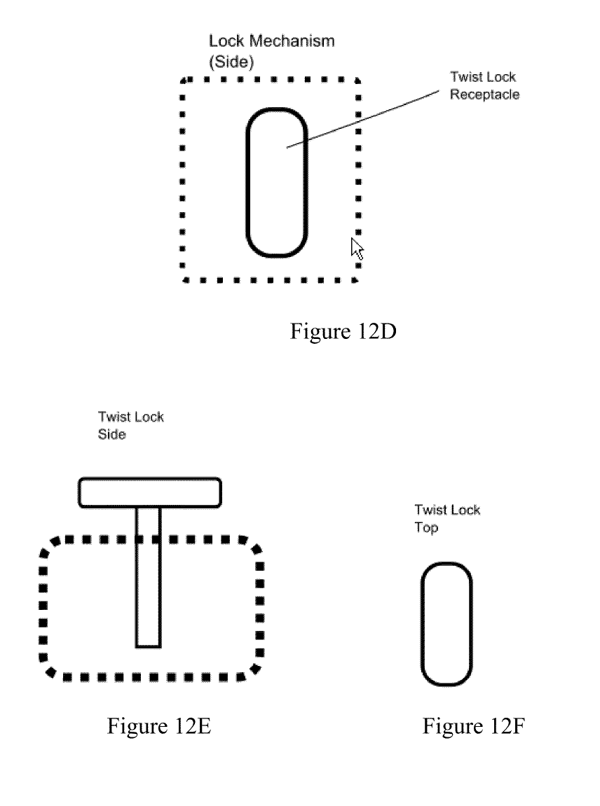

FIGS. 12A-C provide additional details about the pedestal (300). FIG. 12A shows the pedestal (300) taking the form of an elongated cylindrical tube, with a top portion constituting a main shaft (310) for coupling to standardized modules and a bottom pedestal locking shaft (320) for securing the pedestal (300) to the base terminal (200). The diameter of the main shaft (310) measured from its outer edges, may be greater than the diameter of the air passage hole (210) of the base terminal. The pedestal locking shaft (320), which protrudes from the bottom of the main shaft (310), has an outside diameter less than that of the main shaft (310). The outer diameter of the pedestal locking shaft (320) is substantially the same as the inner diameter of the air passage hole (210) of the base terminal (200) so that the pedestal locking shaft (320) may fit within the air passage hole (210). Once the pedestal locking shaft (320) is inserted, the pedestal lock (220) of the base terminal may be actuated to secure the pedestal (300) to the base terminal (200).

The pedestal's (300) main shaft (310) may include one or more locking tracks (330), which are configured to allow standardized modules to slide down and be secured against the locking tracks (310). The main shaft (310) may accommodate multiple standardized modules and may be extended or contracted.

The center of the pedestal is an air passage hole (310) that extends from the top of the pedestal to the bottom (as depicted in FIGS. 12B and 12C), having an inner diameter that is less than both the outer diameters of the main shaft (310) and pedestal locking shaft (320). The air passage hole (340) provides a passive cooling system for standardized modules coupled to the pedestal (300).

To accommodate modules that may be coupled to the top of the pedestal (300), the top surface of the pedestal (300) as depicted in FIG. 12B includes one or more communication ports, such as USB ports (350). The inner surface of the air passage hole (340) may include pedestal locks (355) for securing components coupled to the pedestal's inner surface. FIGS. 12E and 12F show embodiments of the pedestal locks (355) being twist locks. The pedestal lock toggle (360) located on the side surface of the pedestal (300) controls the actuation of the pedestal locks (355).

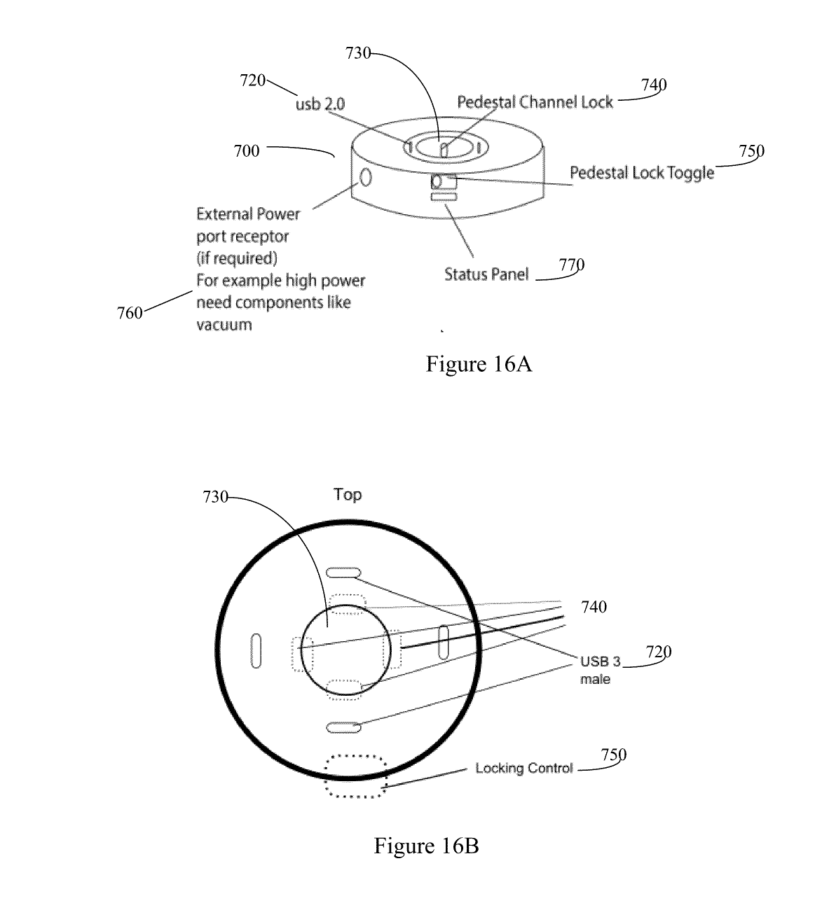

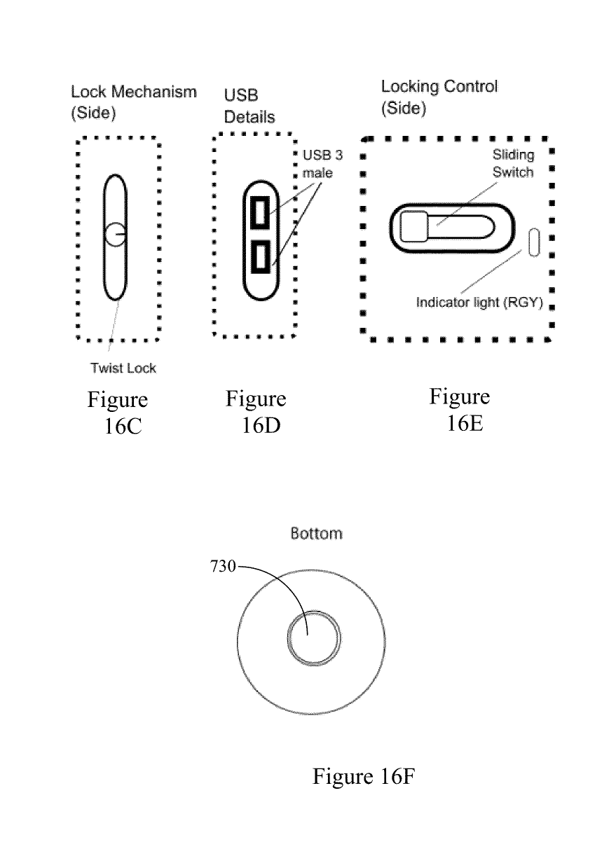

FIG. 12B shows one embodiment where the outside surface of the pedestal (300) may include locking mechanisms (345) for coupling with modules. FIG. 12D shows an embodiment of the locking mechanism (345) being a twist lock receptacle, which may be configured to be coupled with a standardized module's twist lock, as shown in FIG. 16C.

The outer surface of the pedestal (300) may also include a panel (370) for displaying the status or control menu of the pedestal (300).

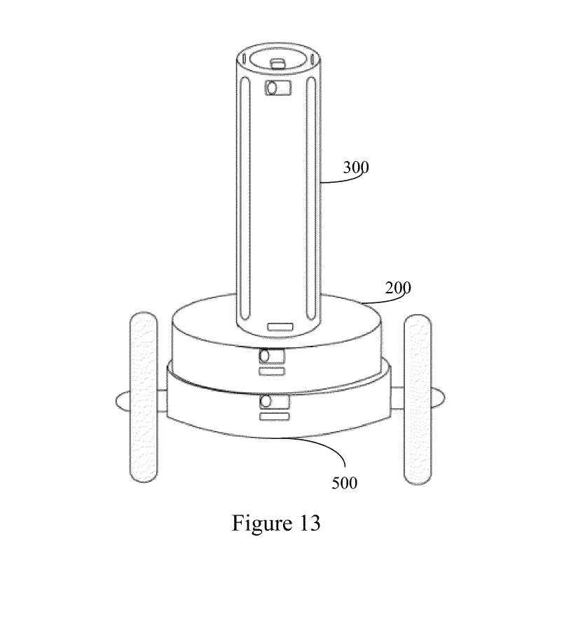

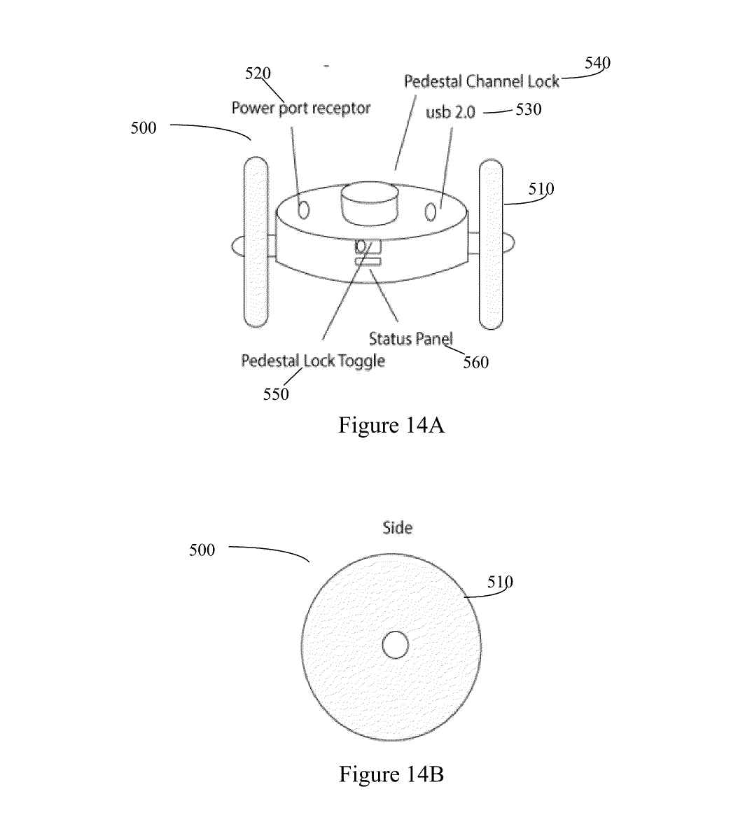

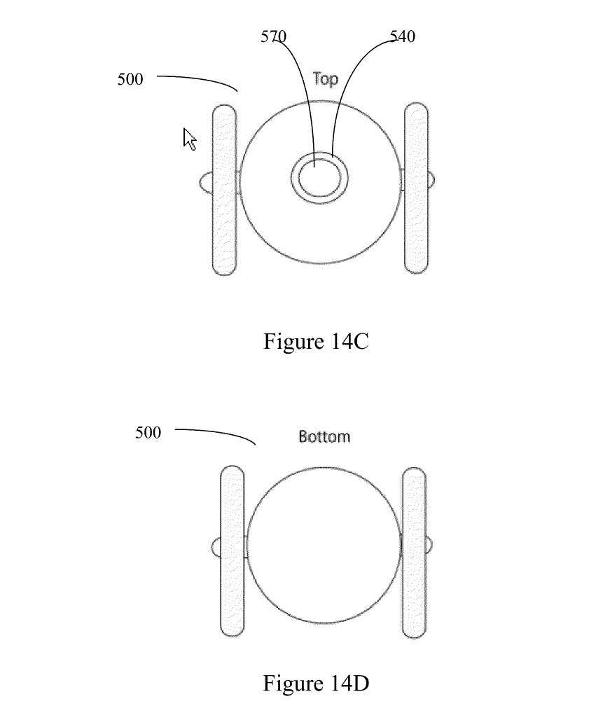

FIG. 13 shows the base terminal (200) and pedestal (300) coupled together with a locomotion module (500). The locomotion module provides the ERiC robotic system with a means to move around and could be implemented by any means known in the art (e.g., wheels, tracks, robotic legs, etc.). FIGS. 14A-14D provide additional detail about the locomotion module (500). FIG. 14A depicts an embodiment where the means for movement is a pair of wheels (510), which may be controlled by logic residing within the locomotion module (500). If locomotion is not needed, the base terminal (200) may also be coupled to a stationary module that provides the desired support.

The standardized interface on the top surface of the locomotion module (500) includes a power receptor (420) and a communication port (e.g., USB) (530), which are configured to be coupled with the base terminal's (200) bottom-surface power port (290) and communication port (295), respectively. Through the connections, the base terminal may supply power to and communicate with the locomotion module (500). Other standardized modules stacked on top of the base terminal may also communicate with the locomotion module (500) through the base terminal (200) or directly through wired or wireless means.

The interface for securing the locomotion module (500) to the base terminal (200) is also standardized. In the embodiment depicted in FIG. 10A, the base terminal's (200) locomotion locking ports (240) may be used as the locking mechanism for securely coupling to the locomotion module (500). Alternatively or in addition, the top of the locomotion module (500), as depicted in FIG. 14A, may have a cylindrical protrusion (540) with a diameter substantially the same as the inner diameter of the base terminal's (200) air passage hole (210) such that the protrusion (540) may slide into the air passage hole (210). In an alternative embodiment the cylindrical protrusion (540) may be configured to slide within the pedestal's (300) air passage hole (340) while the pedestal (300) is coupled to the base terminal (200). In such case the diameter of the protrusion (540) would be substantially similar to that of the pedestal's (300) air passage hole (340). Once the cylindrical protrusion (540) has been inserted into either the base terminal (200) or the pedestal (300), the locomotion module's (500) lock toggle (500) may be actuated to secure the coupling.

The locomotion module (500) may have its own processor and control logic on board to control the module (500) and to communicate with other standardized modules or the base terminal (200). The side of the locomotion module (500) may include a panel (560) for displaying the locomotion module's (500) status or menu options.

FIG. 14B shows a side view of the locomotion module (500). In the particular depicted embodiment, the side surface of the wheel (510) eclipses the rest of the locomotion module (500). FIG. 14C is a top view of the locomotion module (500). To provide for heat dissipation, an air passage hole (570) extends through the locomotion module (500) and the cylindrical protrusion (540). FIG. 14D shows a bottom view of the locomotion module (500). The bottom surface may also have a standardized interface for coupling to any additional modules.

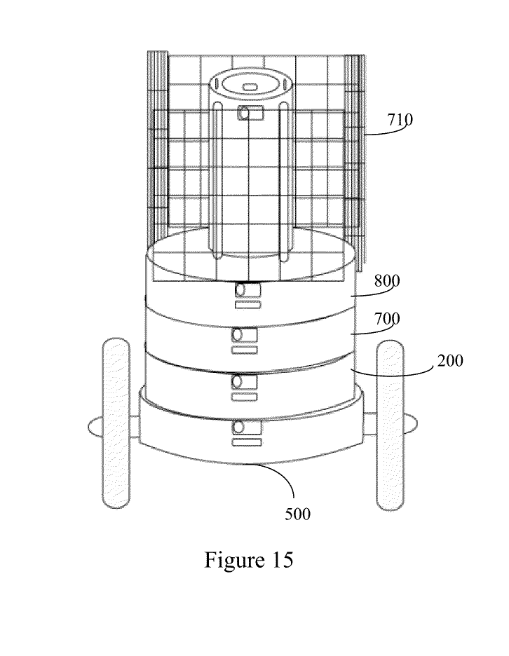

FIG. 15 shows the base terminal (200), pedestal (300), and locomotion module (500) coupled together with two standardized modules (700 and 800) and a basket (710). Each of the standardized modules may perform a different function. The basket (710) may be used as a shopping basket or protection for the pedestal.

While each standardized module may perform different functions, they adhere to a standard interface to connect with each other and to the base terminal (200) and pedestal (300). FIG. 16A shows one embodiment of the standardized module (700) configured to be stackable with other standardized modules (e.g., 800) and the base terminal (200). Its top surface includes communication ports (720). The communication ports (720) may be configured in a manner shown in FIG. 16B. FIG. 16D shows an embodiment of the communication ports (720) being USB male ports. The bottom surface of the standardized module (700) may include communication receptacles (e.g., USB female ports, not shown) for the same type of communication port.

To stack two standardized modules, one standard module's (e.g., 700) bottom communication receptacle may be coupled with the other standardized module's (e.g., 800) top communication port. In this manner, any number of standardized modules may be stacked together. A standardized module (700) is also configured to relay communication it receives from its adjacent top module to its adjacent bottom module and vice versa. This relaying capability provides a means for a module to communicate with non-adjacent modules (e.g., standardized module 800 may communicate with the base terminal 200 through standardized module 700).

The standardized module (700) may have a pedestal hole (730) that extends from the module's top surface to its bottom surface, as shown in FIGS. 16B and 16F. The inner diameter of the hole is substantially the same as that of the outer diameter of the pedestal (300). To secure the standardized module (700) to the ERiC robotic system, the standardized module (700) may slide down the pedestal (300), with the pedestal (300) going through the standardized module's (700) pedestal hole (730). Once the standardized module (700) is coupled with another standardized module beneath it or the base terminal (200), the locking toggle (750) may be actuated to engage the pedestal channel lock (740), located on the inner surface of the pedestal hole (730), to secure the standardized module (700) against the pedestal (300). In one embodiment, pedestal channel locks (740) and locking toggle (750) may be configured in the manner shown in FIG. 16B. FIG. 16C shows an embodiment of the pedestal channel lock (740) being a twist lock, which may couple with the pedestal's twist lock receptacle as shown in FIG. 12D. FIG. 16E shows an embodiment of the locking toggle (750) being a sliding switch with a status indicator light.

The standardized module (700) includes a processor and operating system, firmware, or other software that, inter alta, control the standardized module (700) and brokerage communications between the standardized module (700) and any connected standardized modules and/or base terminal (200). The status of the standardized module (700), as well as any control menu or options, may be displayed on the side surface's display panel (770). The side surface of the standardized module (700) also includes an external power port (760) so that high power consumption modules could directly connect to a power source.

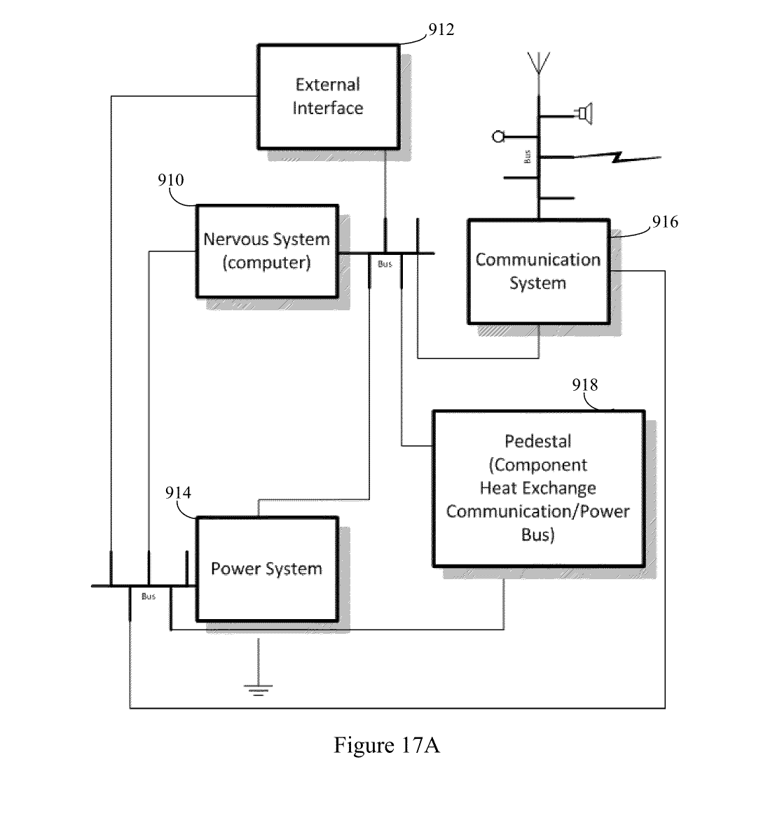

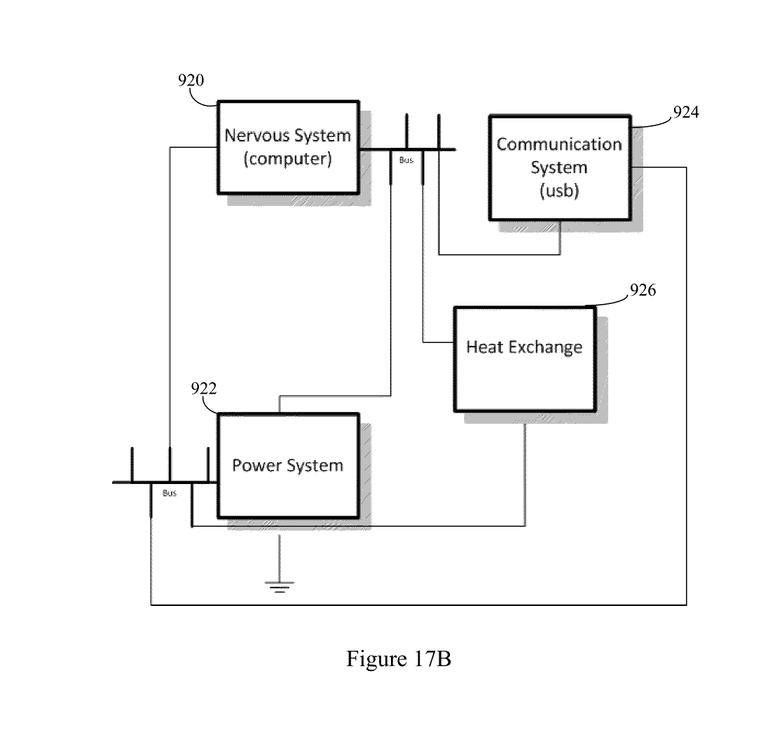

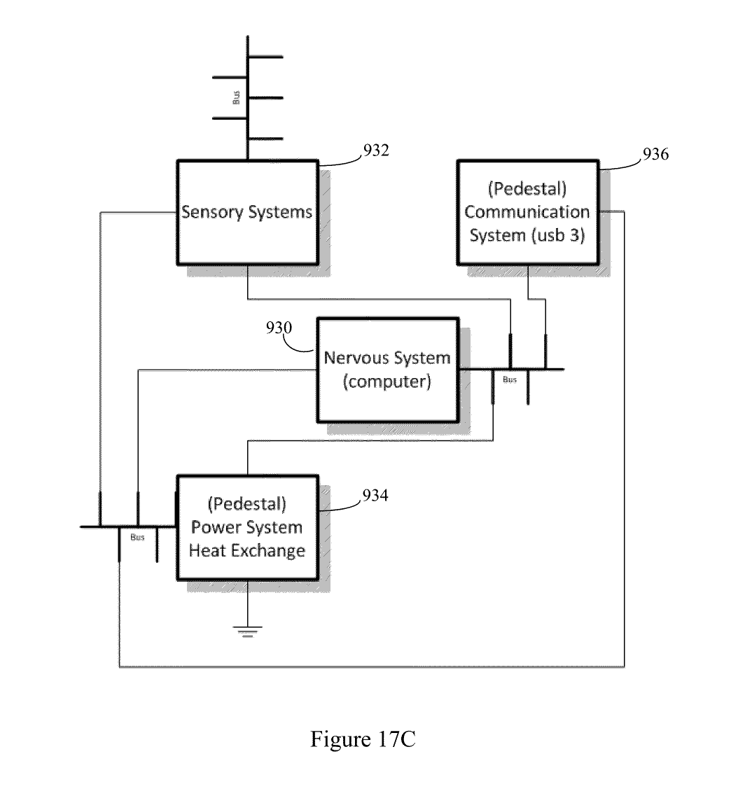

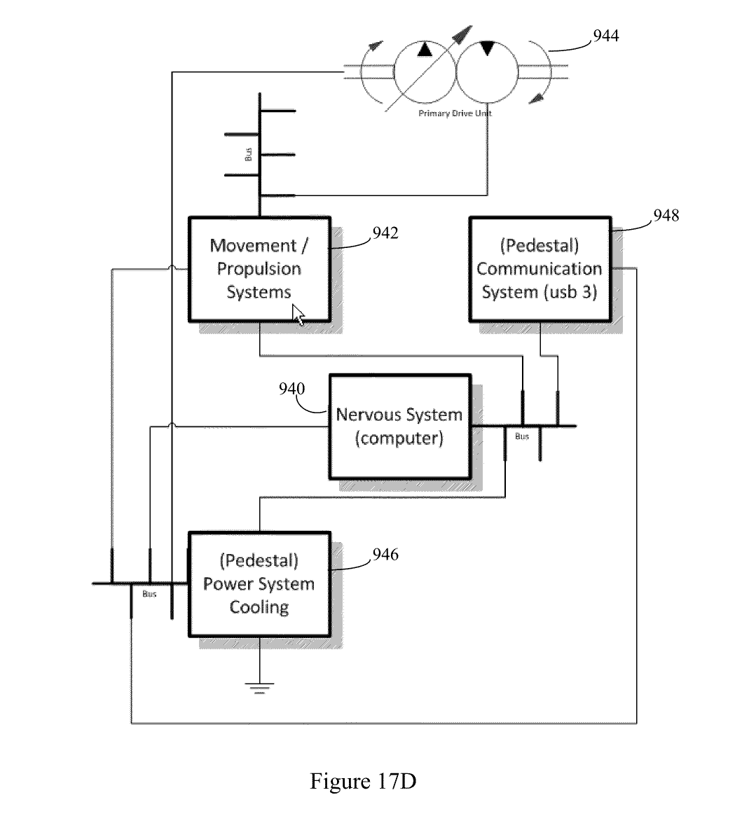

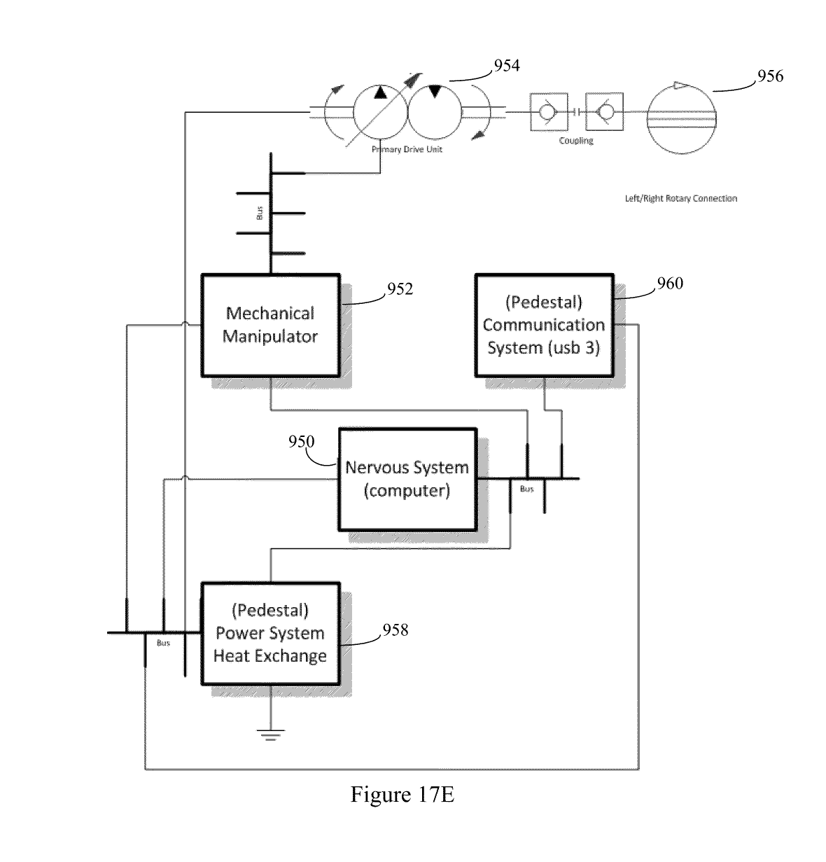

FIGS. 17A-E depict examples of how system components and modules may interconnect. FIG. 17A shows an example of a base module, which comprises a computer nervous system (910), external interface (912), power system (914), and communication system (916), connected to a pedestal (918). The nervous system (910) is configured to communicate with each of the other base module components (i.e., 912, 914, and 916) and with the pedestal (918) through a system bus. The power system (914) is configured to supply operating power to each of the base module components (i.e., 910, 912, and 916) and to the pedestal (918).

FIG. 17B shows an example of a pedestal's interconnected components. The pedestal may have a nervous system (920) configured to communicate with the power system (922), communication system (924), and heat exchange system (926) through a system bus. The power system (922) is configured to provide power to each of the other components (i.e., 920, 924, and 926).

FIG. 17C shows an example of a sensory module connected to a pedestal. The sensory module comprises a nervous system (930) and sensory system (932), which is configured to connect with other external devices through the system bus. The nervous system (93o) is configured to connect to the sensory system (932), the pedestal's communication system (936), and the pedestal's power system and heat exchange (934). The pedestal's power system and heat exchange system (934) provides power and heat dissipation for the pedestal's communication system (936) and the sensory module's nervous system (930) and sensory system (932).

FIG. 17D shows an example of a locomotion module connected to a pedestal. The locomotion module comprises a nervous system (940) and movement/propulsion system (942), which is configured to connect to the primary drive unit (944) of a transportation means (e.g., wheels). The nervous system (940) is configured to connect to the movement/propulsion system (942), the pedestal's communication system (948), and the pedestal's power system and cooling system (946). The pedestal's power system and cooling system (946) provide power and heat dissipation for the pedestal's communication system (948), the primary drive unit (944), and the locomotion module's nervous system (940) and movement/propulsion system (942).

FIG. 17E shows an example of a mechanical manipulator module connected to a pedestal. The mechanical manipulator module comprises a nervous system (950) and mechanical manipulator system (952), which is configured to connect to the primary drive unit (954) of a transportation means (e.g., wheels). The primary drive unit (954) may be coupled to a left/right rotary connection (956). The nervous system (950) is configured to connect to the mechanical manipulator system (952), the pedestal's communication system (960), and the pedestal's power system and heat exchange system (958). The pedestal's power system and heat exchange system (958) provide power and heat dissipation for the pedestal's communication system (960), the primary drive unit (954), and the mechanical manipulator module's nervous system (950) and mechanical manipulator system (952).

As other examples of the wide applicability of the systems and methods disclosed herein, the systems and methods can be configured so as to minimize or eliminate robots being built in a completely or partially proprietary fashion. This obviates robot manufacturers from having to design and build every component of the robot which does not allow them to simply focus on a single component serving a particular function of the overall robot. This is so even though the manufacturer may have particular expertise in a particular component (e.g., mobility components) and little experience in others (e.g., sensory components). This also may obviate manufacturers from requiring them to design an entire robot—rather than just a component. Elimination of this can result in a more efficient use of resources and lowers the barrier to entry to the robotics market. This can lead to a modular robot platform which allows flexible integration of various standardized modules.

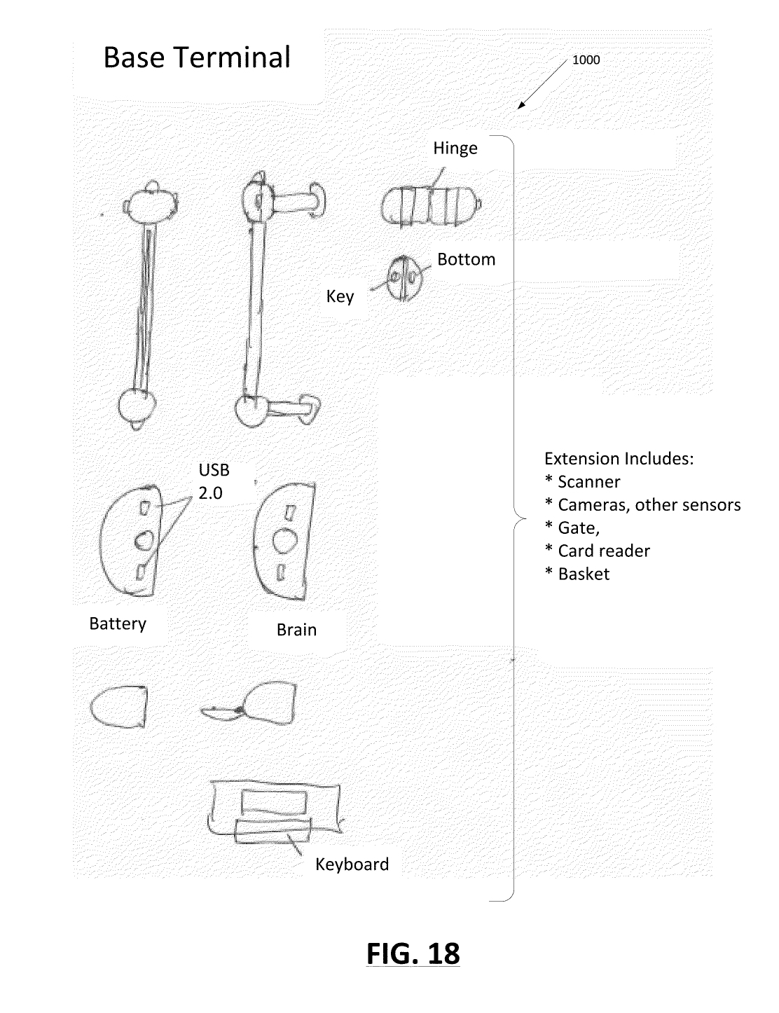

For example, the systems and methods can be configured to operate with a fixed-point robotic extendable doorperson. There are many services and actions that occur in a doorway setting which could be augmented or replaced with a robot but no platform exists to enable a host of services to be provided. This solution is an extendable fixed-point robotic platform would be designed to integrate various solutions and services at one common point. Such a platform can allow third parties to create new appliance which could integrate with all appliances contained on the platform. As an illustration, instead of allowing a locomotion component this system is mounted on a fix point to secure it and provide a constant energy supply. Such systems and methods can operate as a standalone unit using batteries and solar cells if desired. The main base terminal is secured to prevent tampering and provide a communication, power supply and cooling conduit. As shown in FIG. 18 at 1000, the platform can include a scanner; cameras, other sensors; gate; card reader; and a basket.

Examples of situations where such configurations can be used:

1. Consumer's front doors for security and package delivery

2. Business entry ways for security and greeting

3. Merchant exits for self check out.

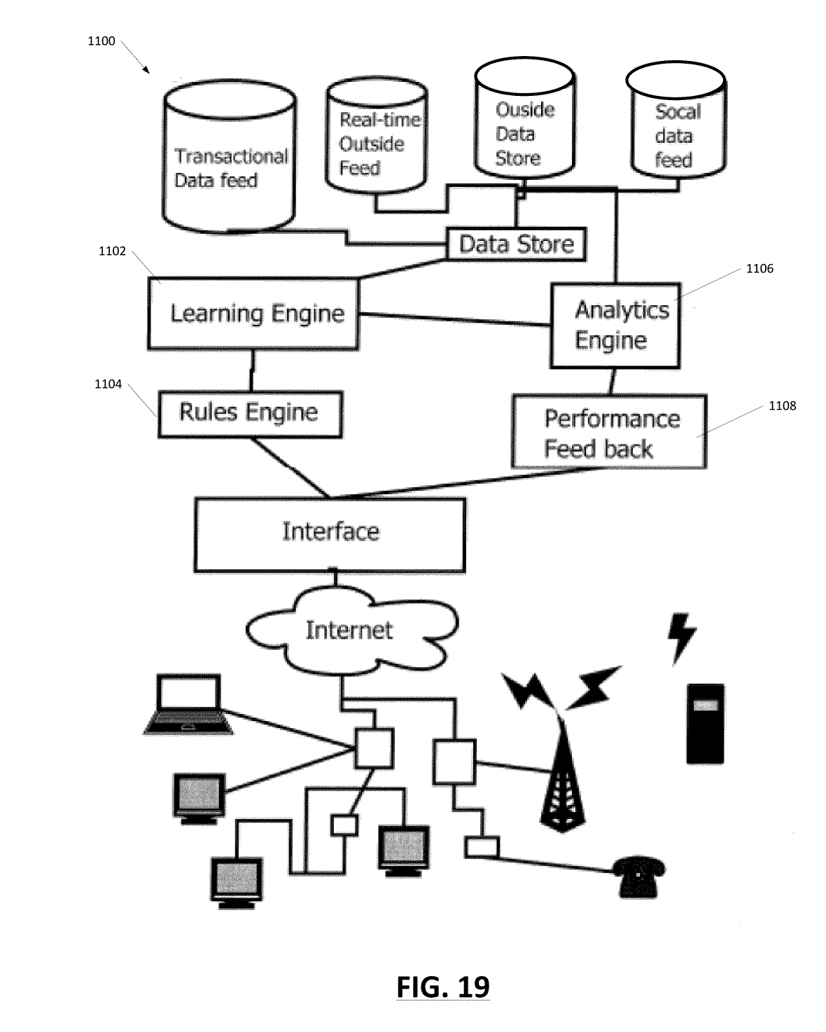

As other examples of the wide scope of the systems and methods disclosed herein, a system can be configured so that there are automated ways to survey emotions across a crowd of people realtime in a defined geographic setting as described at 1100 in FIG. 19. One use of such a system is to enable merchants to better predict consumer behavior and attract nearby people into their stores. Systems and methods can include would incorporate a number of remote sensor technologies to accurately measure a user's emotions real-time within a defined geographic area. More specifically, the systems and methods can use a number of different technologies to monitor consumer behavior. These sensor technologies can be correlated to outcome in transactional and outside data to provide near real-time prediction of consumer moods by using a learning engine 1102, rules engine 1104, analytics engine 1106, and performance feedback 1108. The sensors can be adjusted for regional differences.

Detection and determining moods and emotions can come from a number of sources, such as:

Videos

Motion

Apparel: color

Facial expressions

Voice

Tone

Patterns

Amplitude

Frequency

Accelerometer

Type of Movement

Frequency of Movement

Chemical analysis Devices

Change in Body Chemistry

Change in Skincare Products

Change in Environment

As other examples, understanding and quantifying consumer sentiment at an aggregate or micro level is useful for many economic predictive models. Survey data can be used but it can be biased by a number of factors typical for any survey. Survey questions are interrupted differently by different people leading to misleading and varying results. The types of people who respond to surveys are a bias sample of the general population. And, in addition, surveys average out information across time and space smoothing out granular data needed to better model consumer behavior .

Accordingly, systems and methods can be configured to process the spontaneous nature of transactional data to provide better insights into true consumer sentiment. Systems as disclosed herein could use transactional and outside data to quantify cardholder's moods at both an aggregate and micro level. Such systems can reveal micro-moods that are smoothed out in aggregated questionnaires and polls. For example, systems could digest outside data sources and extract emotional content indexes from these sources. After adjusting for regional and temporal differences these emotional indexes could be matched to transactional data to build predictive models that provide a rich and accurate view of consumer sentient and moods. These models then could predict future consumer sentiment providing near-real-time measure of consumer emotions at any summery level.

As shown in FIG. 19, emotions can be extracted from many different sources:

Regional news

Weather

Stock markets

Movie themes

Local Sports

Employment

Traffic Conditions

As further examples of the wide scope of the systems and methods disclosed herein videos surveillance is an effective means of both risk control and consumer analysis. However, an issue with video surveillance is it is costly, timely and its effectiveness depends on the employees doing the surveillance. As the need and demand for videos surveillance increases the quality of the monitoring is becoming increasingly more difficult. Systems and methods can be configured to provide system to enable automated video surveillance based on correlation between recorded behavior and outcome from transactional histories. As an illustration, systems and methods could provide an analytical solution that can perform an autonomous video surveillance for both risk and marketing purposes. Videos for predicting adverse actions can include: returns, theft, body motion, facial expression, patterns of movement.

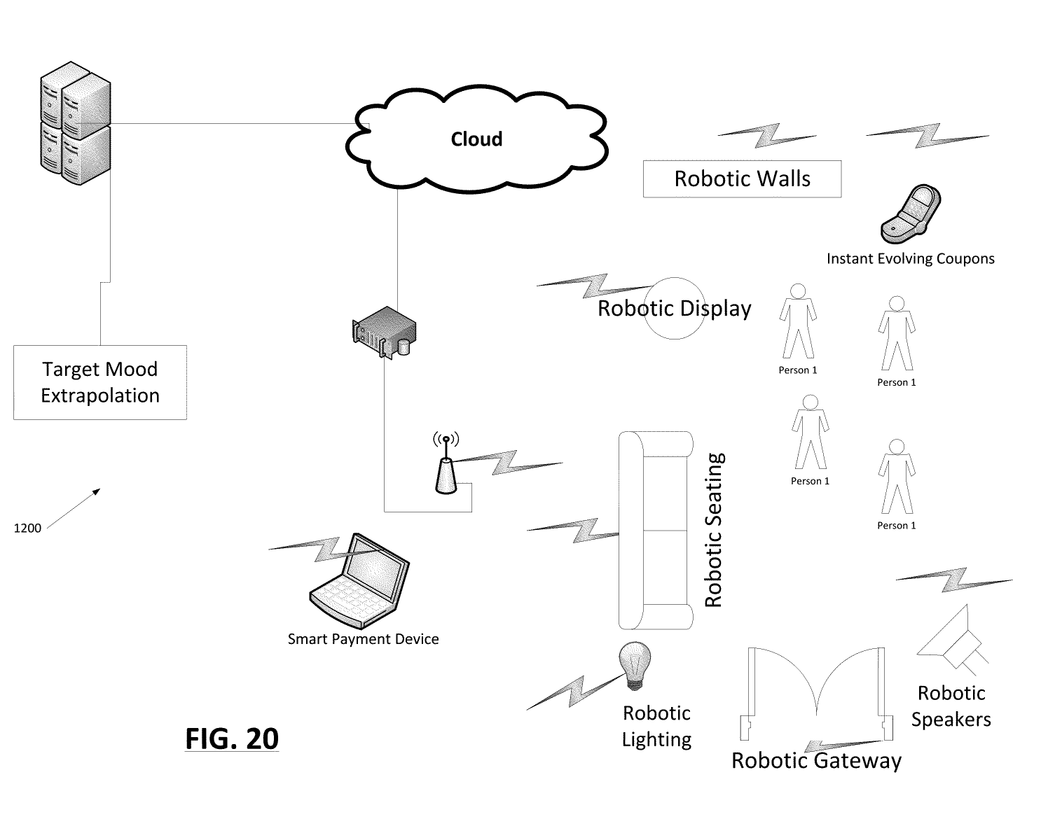

FIGS. 20-22 depict additional examples of such features. With reference to FIG. 20, one or more servers operate as a central control unit to perform target mood extrapolation at 1200 by using the one or more of the techniques depicted in FIG. 19. The mood extrapolation system can be configured to use remote sensors to scan people's facial expressions, sounds, smells as well as outside data such as social feeds to create a situational profile for a designated target zone.

This profile is fed into a central control unit which then looks at a target outcome to determine the optimal modification of physical and virtual objects within the target zone. Example physical objects are, lights, speakers, automated furniture, automated merchandize displays, automated mannequins, window treatments, gates, décor and adaptive wall and ceilings. Example virtual objects are social sites, coupons, ads, text messaging. The system adapts these objects within the geographic zone and create unique physical and virtual incentives for people within that zone to help their aggregate mood to move towards a specified end goal.

For example, if people seem bored, the system can brighten the light, speed up the tempo of the music, summon entertainment robots and reconfigure décor, walls, ceiling and seating. The system can use adaptive algorithms, advanced sensors, and dynamic sounds, visuals, setting and intelligent devices/robots to create a unique adaptive environment that evolves to either complement or defuse a current situation. The system can be used for a mall or event of big box setting. It could also be purposed for security means opening up access points in case of an emergency, trying to calm bi-standards, providing images to rescue personal. It can behave as a fully automated and autonomous system or understand human guidance.

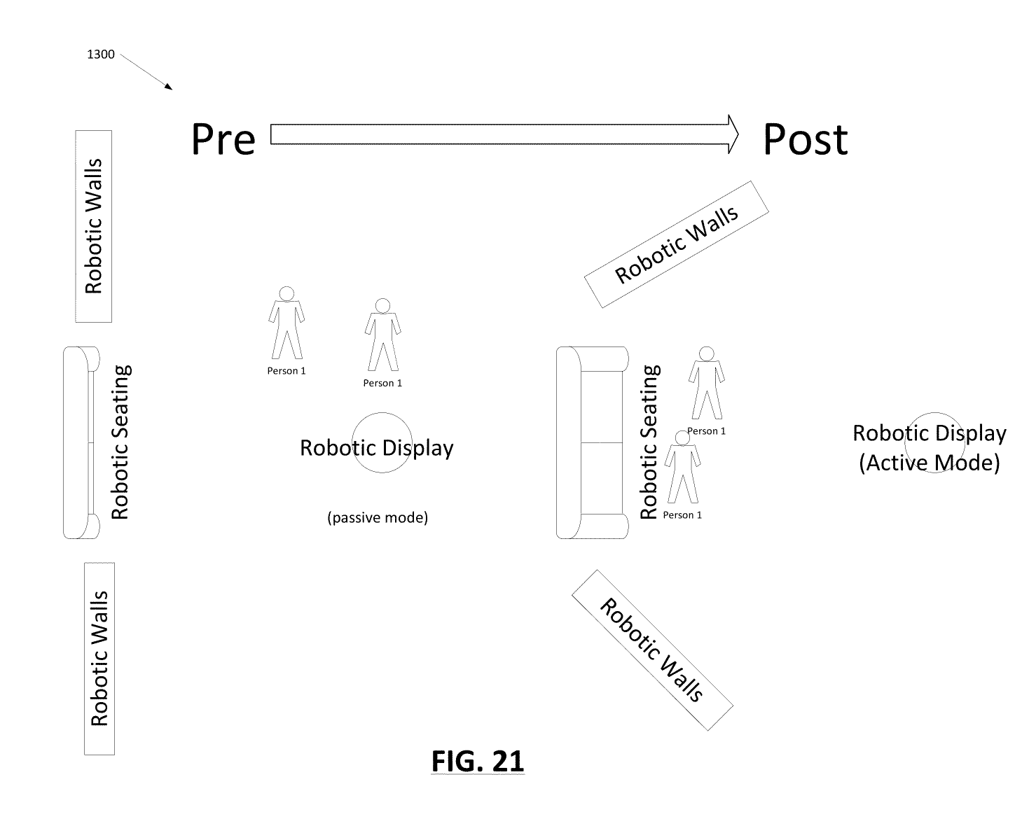

FIG. 21 provides another mood modification example at 1300. In this scenario, two people walk through the geographical targeted zone. Sensors detect and transmit details of their behavior. The mood engine determines the best course of action is to create a passive environment. The robots then create seating and start a active product display to engage the users.

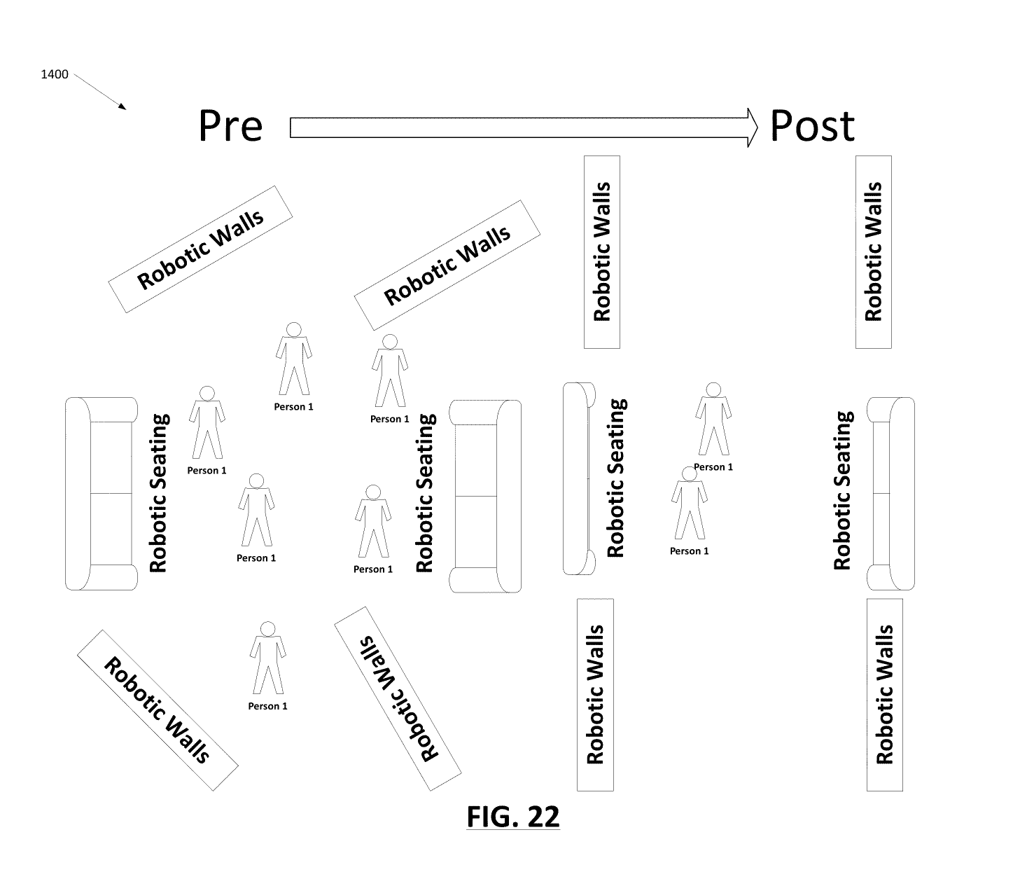

FIG. 22 provides get another mood modification example at 1400 where security is the focus. In this scenario, an emergency requires immediate egress of the facility. The robots (e.g., robotic walls and seating) reconfigure the layout to guide users out.

The wide scope of the systems and methods disclosed herein are further illustrated by the many different types of data processing component, such as storage media and computer-readable media for containing code, or portions of code, including any appropriate media known or used in the art, and including storage media and communication media, such as but not limited to volatile and non-volatile, removable and non-removable media implemented in any method or technology for storage and/or transmission of information such as computer-readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate other ways and/or methods to implement the various embodiments.

The above description is illustrative and is not restrictive. Many variations of the invention may become apparent to those skilled in the art upon review of the disclosure. The scope of the invention may, therefore, be determined not with reference to the above description, but instead may be determined with reference to the pending claims along with their full scope or equivalents.

It may be understood that the present invention as described above can be implemented in the form of control logic using computer software in a modular or integrated manner. Based on the disclosure and teachings provided herein, a person of ordinary skill in the art may know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

One or more features from any embodiment may be combined with one or more features of any other embodiment without departing from the scope of the invention.

A recitation of “a”, “an” or “the” is intended to mean “one or more” unless specifically indicated to the contrary.

In order to address various issues and advance the art, the entirety of this application (including the Cover Page, Title, Headings, Field, Background, Summary, Brief Description of the Drawings, Detailed Description, Claims, Abstract, Figures and/or otherwise) shows by way of illustration various example embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further non-described alternate embodiments may be available for a portion is not to be considered a disclaimer of those alternate embodiments. It will be appreciated that many of those non-described embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any data flow sequence(s), program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations-in-part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of an ERiC robot, various embodiments of the ERiC robot may be implemented and may be readily configured and/or customized for a wide variety of other applications and/or implementations.

What is claimed is:

1. A system for automatic reconfiguration of robotic furniture components, comprising:
one or more sensors for detecting behavior data of multiple users within a region;
a data processor configured to:
process the detected behavior data;
generate a control signal based on the processed behavior data and external data feeds; and
transmitting the control signal to one or more of the robotic furniture components to automatically reconfigure.

2. The system of claim 1, wherein the one or more sensors are configured to detect at least one of people's facial expressions, sounds, or smells.

3. The system of claim 1, wherein the one or more of the robotic furniture components include at least one from the group: lights, speakers, automated furniture, automated merchandize displays, automated mannequins, window treatments, décor or adaptive wall and ceilings.

4. The system of claim 1, wherein the one or more of the robotic furniture components include robotic walls and robotic seating components.

5. The system of claim 1, wherein the robotic walls and robotic seating components are reconfigured in response to an emergency mood detection;
wherein the robotic walls and robotic seating components are reconfigured to facilitate exit of one or more people.

6. The system of claim 5, wherein the robotic walls in robotic seating components contain mechanisms for movement which activate in response to the control signal.

7. The system of claim 1, wherein the data processor determines based upon the detected behavior data that a passive environment is to be created.

8. The system of claim 7, wherein the control signal transmitted to the one or more of the robotic furniture components results in the one or more of the robotic furniture components reconfiguring in order to create a passive environment.

9. The system of claim 1, wherein the external data feeds include at least one from the group of regional news, weather, stock markets, movie themes, local sports, employment, traffic conditions.

10. The system of claim 1, wherein at least one of the robotic furniture components includes:
a base terminal including a power connector configured to receive electrical power from a power supply; and
a pedestal coupled to the base terminal, the pedestal being configured to accept a plurality of standardized modules,
wherein the plurality of standardized modules receive the electrical power from the power connector, and
wherein the base terminal or the pedestal includes electrical connections configured to provide communications between modules of the plurality of standardized modules.

11. A method for automatically reconfiguring robotic furniture components, said method comprising:
using sensors to detect behavior data of multiple users within a region;
processing, by one or more data processors, the detected behavior data;
generating, by the one or more data processors, a control signal based on the processed behavior data and external data feeds; and
transmitting the control signal to one or more of the robotic furniture components to automatically reconfigure.

12. The method of claim 11, wherein the one or more sensors are configured to detect at least one of people's facial expressions, sounds, or smells.

13. The method of claim 11, wherein the one or more of the robotic furniture components include at least one from the group: lights, speakers, automated furniture, automated merchandize displays, automated mannequins, window treatments, décor or adaptive wall and ceilings.

14. The method of claim 11, wherein the one or more of the robotic furniture components include robotic walls and robotic seating components.

15. The method of claim 11, wherein the robotic walls and robotic seating components are reconfigured in response to an emergency mood detection;
wherein the robotic walls and robotic seating components are reconfigured to facilitate exit of one or more people.

16. The method of claim 15, wherein the robotic walls in robotic seating components contain mechanisms for movement which activate in response to the control signal.

17. The method of claim 11, wherein the data processor determines based upon the detected behavior data that a passive environment is to be created.

18. The method of claim 17, wherein the control signal transmitted to the one or more of the robotic furniture components results in the one or more of the robotic furniture components reconfiguring in order to create a passive environment.

19. The method of claim 11, wherein the external data feeds include at least one from the group of regional news, weather, stock markets, movie themes, local sports, employment, traffic conditions.

20. The method of claim 11, wherein at least one of the robotic furniture components includes:
a base terminal including a power connector configured to receive electrical power from a power supply; and
a pedestal coupled to the base terminal, the pedestal being configured to accept a plurality of standardized modules,
wherein the plurality of standardized modules receive the electrical power from the power connector, and
wherein the base terminal or the pedestal includes electrical connections configured to provide communications between modules of the plurality of standardized modules.
